(19) United States
(12) Patent Application Publication
(10) Pub. No.: US 2008/0155045 A1
(43) Pub. Date: Jun. 26, 2008

(54) Group management system, server system and program therefor

(75) Inventor: Toshifumi Koyama, Sapporo City (JP)

Correspondence Address: MASUVALLEY & PARTNERS, 8765 AERO DRIVE, SUITE 312, SAN DIEGO, CA, 92123, US

(73) Assignee: TOKYO ELECTRON LIMITED, Tokyo (JP)

(21) Appl. No.: 12/001,364

(22) Filed: Dec. 10, 2007

(30) Foreign Application Priority Data
Dec. 12, 2006 (JP) JP2006-334273

(51) Int. Cl. G06F 15/16; G06F 17/00

(52) U.S. Cl. 709/206; 700/110

(57) ABSTRACT

A group management system includes a manufacturing apparatus 11 including a status information transmission section 1107, which transmits the status information of a self-apparatus, server apparatus 12 including an abnormal detection section 1205, which detects occurrence of the abnormalities of not less than one manufacturing apparatus 11 using at least a part of the status information received by server side reception section 1201, an abnormal notice information configuration section 1206, which composes the abnormal notice information notifying occurrence of the abnormalities including apparatus discernment information corresponding to the manufacturing apparatus 11 in which the abnormalities occurred when abnormal detection section 1205 detects that abnormalities occurred, and a server side transmission section 208, which transmits abnormal notice information to prescribed client apparatus 13, and a client apparatus 13 including an output section 1302 for outputting abnormal notice information which client side reception section 1301 received.

### TECHNICAL FIELD

The present invention relates to a group management system having a function for performing an abnormal detection including a server apparatus connected with not less than one manufacturing apparatus executing a prescribed process to a substrate to be processed, and not less than one client apparatus connected with the server.

### BACKGROUND OF THE INVENTION

With respect to a group management system of the conventional semiconductor manufacturing apparatus, Unexamined Japanese Patent Application Publication No. H11-354395 (on the 1st page, FIG. 1) discloses a group management system for receiving various data sent from a measuring instrument, and processing the data. According to the data processing method of this group management system, the formula, which processes measurement data, is registered in advance. When the various measurement data, which the measuring instrument transmits to the measuring instrument communication section of the group management section of a group management system, are received, a measurement data reception buffer stores the measurement data. Based on the recipe name, which the measurement data has, a formula with at least one same recipe name suitable for processing the measurement data is simultaneously chosen from the registered formulas, and stored in a formula storage buffer. The stored measurement data is calculated in the selected formula, and a calculation result is stored in a processed data storage buffer.

Unexamined Japanese Patent Application Publication 2006-216920 (on the 1st page, FIG. 1) discloses the structure for detecting the abnormalities of a semiconductor manufacturing apparatus.

What is called a batch type vertical type heat processing apparatus is described in Japanese Patent No. 3,543,996 (on the 1st page, FIG. 1) and Unexamined Japanese Patent Application Publication 2002-25,997 as a manufacturing apparatus, which configures a conventional group management system.

On the other hand, as a controlling device of the conventional semiconductor manufacturing process, for example, Unexamined Japanese Patent Application Publication 2006-501680 (on the 1st page, FIG. 1) discloses a structure for sending an electronic mail to the owner of a tool, when failure is detected.

However, in the conventional group management system, as mentioned above, after receiving the notice of the abnormalities to a manufacturing apparatus via the electronic mail, there was a problem that it was difficult to carry out a quick and suitable response.

For example, in order to know the status of the manufacturing apparatus from which the abnormal notice was received, it is necessary to read the status information of the manufacturing apparatus using a dedicated terminal for monitoring the manufacturing apparatus. However, when a user has received the abnormal notice by a general-purpose computer other than these, there has been a problem that the status and cause of the abnormalities could not be examined immediately and a delay arose in repair works.

In addition, in case when the operation of the terminal for monitoring the abnormalities was not fully understood, even if the operation status till the occurrence of the abnormality of the manufacturing apparatus, what is called a log, was going to be checked by collecting the log, when the notice of the occurrence of the abnormality was received, information regarding the operation status was not able to be acquired. In addition, though operation of such terminal was understood, it was necessary to move the group management system to a location where there is a terminal that can be operated, and it was difficult to respond promptly. In addition, since the input screen for specifying the manufacturing apparatus in which the abnormality has occurred had to be opened, or information, which specifies a manufacturing apparatus, had to be inputted, it took time to process these operations.

In addition, for example, when the abnormality has occurred to the manufacturing apparatus, it was not able to notify that the abnormality has occurred selectively only to the user who is relevant to the manufacturing apparatus corresponding to the manufacturing apparatus in which the abnormality has occurred. As a result, unnecessary notification is given to the user who is unrelated to repair, or unnecessary notice increased. Accordingly, there was a case that an important abnormal notice for a user might be indistinguishable from unnecessary notices. As a result, there was a possibility that the user who needs to carry out reinstatement may overlook an abnormal notice.

In addition, when abnormalities have occurred to a plurality of manufacturing apparatuses, there have been a problem that the acquisition works of an operation status were required for the number of units corresponding to the number of the manufacturing apparatus in which abnormalities occurred, and the acquisition process by a user took time.

### SUMMARY OF THE INVENTION

A group management system having a function for performing abnormal detection, the group management system including,

at least one manufacturing apparatus for executing a prescribed process to a substrate to be processed,

a server apparatus connected with the manufacturing apparatus, and

at least one client apparatus connected with the server apparatus,

wherein the manufacturing apparatus includes

a status information acquisition section for acquiring status information, which is time series information on a status of the manufacturing apparatus, and

a status information transmission section for transmitting the status information, which the status information acquisition section has acquired,

wherein the server apparatus includes

a server side reception section for receiving the status information,

an abnormal detection section for detecting occurrence of abnormality in respect to the manufacturing apparatus using at least a part of status information, which the server side reception section has received,

an abnormal notice information configuration section for configuring abnormal notice information, which is information having at least one apparatus discernment information being information for discerning the manufacturing apparatus corresponding to the manufacturing apparatuses, in which the abnormality has occurred, and is information for notifying the abnormality, when the abnormal detection section has detected that the abnormality has occurred in any one of the manufacturing apparatuses,

a server side transmission section for transmitting the abnormal notice information to prescribed the client apparatus,

a command information reception section for receiving command information, which is information including a command performed in the manufacturing apparatuses in which the abnormality has occurred, and including the apparatus discernment information, which the abnormal notice information includes,

a command execution section for executing a command included in the command information by utilizing the apparatus discernment information included in the command information, and

wherein the client apparatus includes

a client side reception section for receiving the abnormal notice information,

an output section for outputting the abnormal notice information, which the client side reception section received,

a command reception section for receiving the command,

a command information configuration section for configuring the command information using command received by the command reception section and the apparatus discernment information which is included in the abnormal notice information, and

a command information transmission section for transmitting the command information to the server apparatus.

According to this configuration, when inputting the command for performing the process of the manufacturing apparatus in which abnormalities occurred, it is not necessary to input the information, which specifies the apparatus in which abnormalities occurred. For this reason, a user can simplify the process of inputting a command. In addition, it becomes possible to respond promptly to the process for understanding the status of the abnormalities and the process for repairing. In addition, in case when the user does not remember the apparatus discernment information, and even when the user does not fully master how to use the dedicated terminal used in order to obtain the status information of the manufacturing apparatus, it becomes possible to appropriately acquire the information on the status of the manufacturing apparatus in which the abnormalities were detected. Thereby, after receiving the abnormal notice of a manufacturing apparatus, it becomes possible for a user to promptly and appropriately responds the situation. Furthermore, even when abnormalities were detected in a plurality of manufacturing apparatus, one abnormal notice information including the apparatus discernment information of the plurality of manufacturing apparatuses in which the abnormalities were detected is transmitted to a client apparatus. For this reason, a piece of command information configured using this abnormal notice information can be transmitted to a server apparatus. Thereby, the process of the plurality of manufacturing apparatus in which the abnormalities were detected can be instructed at once. For this reason, it becomes possible to simplify the process of transmitting the command, and to respond promptly to the abnormal notice.

The group management system of the present invention,

wherein the server apparatus further includes

an addressee information per apparatus storage section, which is capable of storing information being information including the apparatus discernment information and addressee information, which is information of addressee of the client apparatus corresponding to the apparatus discernment information,

wherein the server side transmission section acquires the addressee information corresponding to the apparatus discernment information of the manufacturing apparatus, in which the abnormality has occurred, in response to the addressee information per apparatus, and transmits the abnormal notice information by utilizing the addressee information, which has been acquired.

According to this configuration, an appropriate user can be selected to the manufacturing apparatus in which the abnormalities occurred, and the occurrence of the abnormalities can be notified. According to this configuration, only required abnormal notice information can be transmitted without transmitting unnecessary abnormal notice information to the user.

The group management system of the present invention,

wherein the command execution section of the server apparatus configures manufacturing apparatus command information including a command, when the command included in the command information is a command to be executed by the manufacturing apparatus,

wherein the server apparatus further includes a manufacturing apparatus command information transmission section for transmitting manufacturing apparatus command information, which has been configured by the command execution section to the manufacturing apparatus corresponding to the apparatus discernment information included in the command information, and

wherein the manufacturing apparatus further includes a manufacturing apparatus command information reception section for receiving the manufacturing apparatus command information and

a process section for executing a command included in the manufacturing apparatus command information.

According to this configuration, when inputting the command for the manufacturing apparatus in which abnormalities have occurred to execute a process, it is not necessary to input the information, which specifies the apparatus in which abnormalities have occurred. Thus, the input process by a user can be reduced. In addition, since the user does not need to remember the apparatus discernment information, the user's burden is eased.

The group management system of the present invention,

wherein the command is a command, which acquires at least a part of the status information,

wherein the server apparatus further includes

a status information storage section into which the status information and the apparatus discernment information are stored,

an accumulation section for correlating the status information, which the server side reception section received, and the apparatus discernment information corresponding to the status information, and for accumulating correlated information into the status information storage section,

a transmission status information acquisition section for acquiring at least a part of status information, which has been correlated with the apparatus discernment information included in the command information corresponding to instructions of the command execution section, and has been stored in the status information storage section, and for configuring transmission status information, which is status information for transmission, and

a transmission status information transmission section, which transmits transmission status information configured by the transmission status information acquisition section to a client apparatus, from which the command information was transmitted, and

wherein the client apparatus further includes

a status information reception section for receiving the transmission status information, and

a status information output section for outputting transmission status information received by the status information reception section.

According to this configuration, even though a user does not input the information specifying the manufacturing apparatus to the command, the status information of the manufacturing apparatus with which abnormalities were detected is acquirable from the server apparatus. Thus, the command to be inputted can be simplified and input process by a user can be reduced. In addition, status information, such as a log of the manufacturing apparatus in which abnormalities were occurred, can be acquired. Thus, it becomes possible to appropriately analyze the status of the manufacturing apparatus where abnormalities were detected, and to appropriately respond to the abnormalities.

The group management system of the present invention,

wherein the client apparatus further includes

an update information reception section for receiving update information, which is information for updating the manufacturing apparatus,

an update instruction information configuration section for configuring update instruction information including update information received by the update information reception section, and the apparatus discernment information included in abnormal notice information received by the client side reception section, and

an update instruction information transmission section for transmitting the update instruction information to the server apparatus,

wherein the server apparatus further includes

an update instruction information reception section for receiving the update instruction information, and

an update information transmission section for transmitting update information included in the command information to the manufacturing apparatus corresponding to apparatus discernment information included in the update instruction information, and

wherein the manufacturing apparatus further includes

an update information reception section for receiving the update information, and

an update execution section for executing update information, which has been received by the update information reception section.

According to this configuration, the manufacturing apparatus in which abnormalities occurred can be easily updated.

The group management system of the present invention, wherein the client apparatus further includes

a server update information reception section for receiving server update information, which is information for the server apparatus to execute update, and

a server update information transmission section for transmitting the server update instruction information to the server apparatus, and

wherein the server apparatus further includes

a server update information reception section for receiving the server update information and

a server update execution section for executing update by using the server update information.

According to this configuration, the operation for updating the server can be simplified by this configuration.

The group management system of the present invention,

wherein transmission and reception of the abnormal notice information are conducted via an electronic mail.

According to this configuration, it becomes possible to know the occurrence of abnormalities by electric equipments, such as a computer capable of transmitting and receiving electronic mails, which is generally and widely spread without using a dedicated terminal. Thus, the cost can be controlled to less expensive. In addition, if there is a location in which the transmission and reception of the electronic mail can be conducted, it become possible to carry out detection and repair work of the abnormalities without going to the location where there is a dedicated terminal. For this reason, a user's manpower can be reduced, while the time related to abnormal detection or a repair process could be shortened. In addition, the check of the occurrence of the abnormality can be easily conducted by using electronic mail, which has generally spread, without learning operation of dedicated terminal. By creating the reply e-mail to this abnormal notice information, the apparatus discernment information included in the abnormal notice information and the e-mail address of the server apparatus from which the electronic mail was transmitted can be reused for the preparation and transmission of the command information and update instruction information. Thereby, a user's work can be reduced or a work error can be reduced.

The group management system of the present invention, wherein transmission and reception of the command information are conducted via an electronic mail, and the command information configuration section configures the command information describing a command received by the command reception section in a reply e-mail corresponding to the abnormal notice information, the reply e-mail being specified to be sent to the server apparatus, from which the abnormal notification information was transmitted.

A server apparatus can be made to execute the command relating to the manufacturing apparatus corresponding to the apparatus discernment information included in the abnormal notice information by this configuration, and the input for specifying the apparatus in which the abnormalities have occurred, when inputting a command, can be simplified. In addition, when the use of the electronic mail, which has generally spread, is understood by a user in case when the user does not remember the apparatus discernment information or has not fully mastered the operation methods of a dedicated terminal used in order to acquire the status information of the manufacturing apparatus, and it becomes possible to appropriately acquire the information of the status of the manufacturing apparatus in which the abnormalities were detected. Furthermore, when the abnormalities were detected in a plurality of manufacturing apparatuses, a piece of the abnormal notice information including the apparatus discernment information of the plurality of manufacturing apparatus in which the abnormalities were detected is transmitted to the client apparatus by an electronic mail. For this reason, a piece of the command information is formed using the reply e-mail to the abnormal notice information, and replied to the server apparatus. Thus, the process of the plurality of manufacturing apparatuses in which the abnormalities were detected can be instructed by the reply of electronic mail at one time. Furthermore, it becomes possible to simplify the process for transmitting the command and to promptly respond to the abnormal notice. In addition, since the status information can be acquired by using an electronic mail, it becomes possible to easily conduct the process from a remote place where there is no dedicated terminal of the manufacturing apparatus. As a result, the speeding up of the process can be attained.

The group management system of the present invention,

wherein transmission and reception of the abnormal notice information and transmission and reception of the update instruction information are conducted via an electronic mail, and the update instruction information configuration section configures the update instruction information, to which the update information is attached, in a reply e-mail having apparatus discernment information included in the abnormal notice information corresponding to the abnormal notice information, the reply e-mail being specified to be sent to the server apparatus, from which the abnormal notice information was transmitted.

According to this configuration, by attaching the update information to the reply e-mail to the abnormal notice information, the manufacturing apparatus corresponding to the apparatus discernment information included in the abnormal notice information can be updated, and the process of update of the manufacturing apparatus can be simplified.

The group management system of the present invention,

wherein transmission and reception of the abnormal notice information and transmission and reception of the server update instruction information are conducted via an electronic mail, and the server update instruction information configuration section configures the server update instruction information, to which the server update information received by the server information reception section is attached, in a reply e-mail corresponding to the abnormal notice information, the reply e-mail being specified to be sent to the server apparatus, from which the abnormal notice information was transmitted.

According to this configuration, by attaching server update information to the reply e-mail to the abnormal notice information, the server apparatus can be updated and the process of update of the manufacturing apparatus can be simplified.

The group management system of the present invention,

wherein transmission and reception of the electronic mail are conducted under a coded condition.

Security can be maintained by this configuration. In addition, since the structure of such security is installed in the electronic mail, the cost of security introduction can be reduced by utilizing this function.

According to the group management system of the present invention, after receiving the abnormal notice of the manufacturing apparatus, it becomes possible to promptly and appropriately respond to it.

### BRIEF DESCRIPTION OF THE DRAWING

FIG. 1 illustrates a conceptual diagram of the group management system in an embodiment of the invention.

FIG. 2 illustrates an example of a manufacturing apparatus of the group management system in an embodiment of the invention.

FIG. 3 illustrates a block diagram of the manufacturing apparatus of the group management system in an embodiment of the invention.

FIG. 4 illustrates a block diagram of a server apparatus of the group management system in an embodiment of the invention.

FIG. 5 illustrates a block diagram of a client apparatus of the group management system in an embodiment of the invention.

FIG. 6 illustrates a flowchart describing operations of the manufacturing apparatus of the group management system in an embodiment of the invention.

FIG. 7 illustrates a flowchart describing operations of the server apparatus of the group management system in an embodiment of the invention.

FIG. 8 illustrates a flowchart describing operations of the client apparatus of the group management system in an embodiment of the invention.

FIG. 9 illustrates status information of the group management system in an embodiment of the invention.

FIG. 10 illustrates a management table of the status information of the group management system in an embodiment of the invention.

FIG. 11 illustrates an example of a template of the group management system in an embodiment of the invention.

FIG. 12 illustrates a management table of addressee information per apparatus of the group management system in an embodiment of the invention.

FIG. 13 illustrates an example of an electronic mail of the group management system in an embodiment of the invention.

FIG. 14 illustrates an example of an electronic mail of the group management system in an embodiment of the invention.

FIG. 15 illustrates an example of an electronic mail of the group management system in an embodiment of the invention.

FIG. 16 illustrates transmission status information of the group management system in an embodiment of the invention.

FIG. 17 illustrates an example of an electronic mail of the group management system in an embodiment of the invention.

FIG. 18 illustrates an example of an electronic mail of the group management system in an embodiment of the invention.

### DETAILED DESCRIPTION OF THE INVENTION

Hereafter, an embodiment of a group management system will be described with reference to the drawings. In addition, since the structural elements to which the same symbol is attached in the embodiment conduct the same operation, the second description may be omitted.

### Embodiment

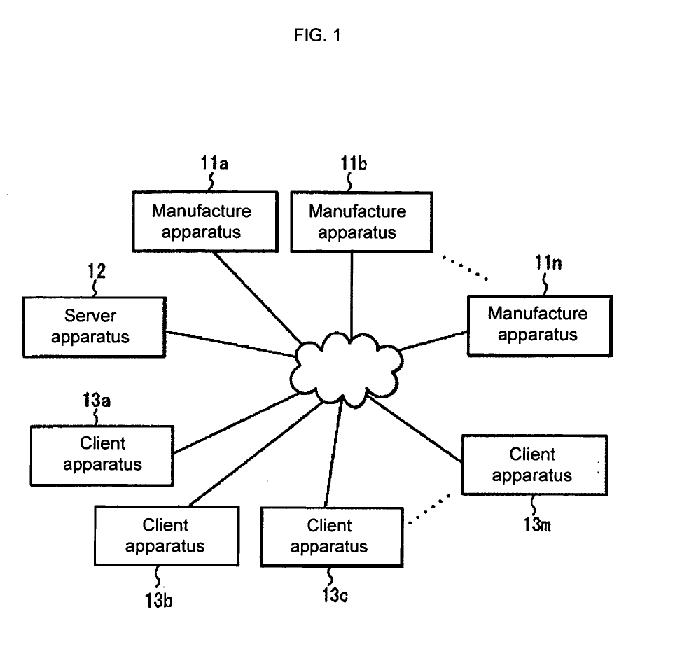

FIG. 1 illustrates a conceptual diagram of the group management system in an embodiment of the present invention. The group management system is, for example, a system, which manages a semiconductor manufacturing apparatus and a manufacturing apparatus, such as a liquid crystal panel manufacturing apparatus. In addition, the group management system has not less than one manufacturing apparatus 11 (from the manufacturing apparatuses 11a to 11n (where, n shows arbitrary number) of manufacturing apparatuses), the server apparatus 12, and not less than one client apparatus 13 (from the client apparatuses 13a to 13m (where m shows arbitrary number) of client apparatuses).

The server apparatus 12 and not less than one manufacturing apparatus 11, and the server apparatus 12 and not less than one client apparatus 13 are capable of respectively transmitting and receiving information through a communication line. Each apparatus, for example, may be connected by networks, such as Internet, wireless or a cable LAN, and may be connected by short-distance wireless communications, such as Bluetooth (registered trademark). In addition, each apparatus may be connected by USB, bus like IEEE1394. However, there is no specific restriction for connection method between respective apparatuses. In addition, a means of communication or a broadcast means may be sufficient as the means of transmission and reception of information.

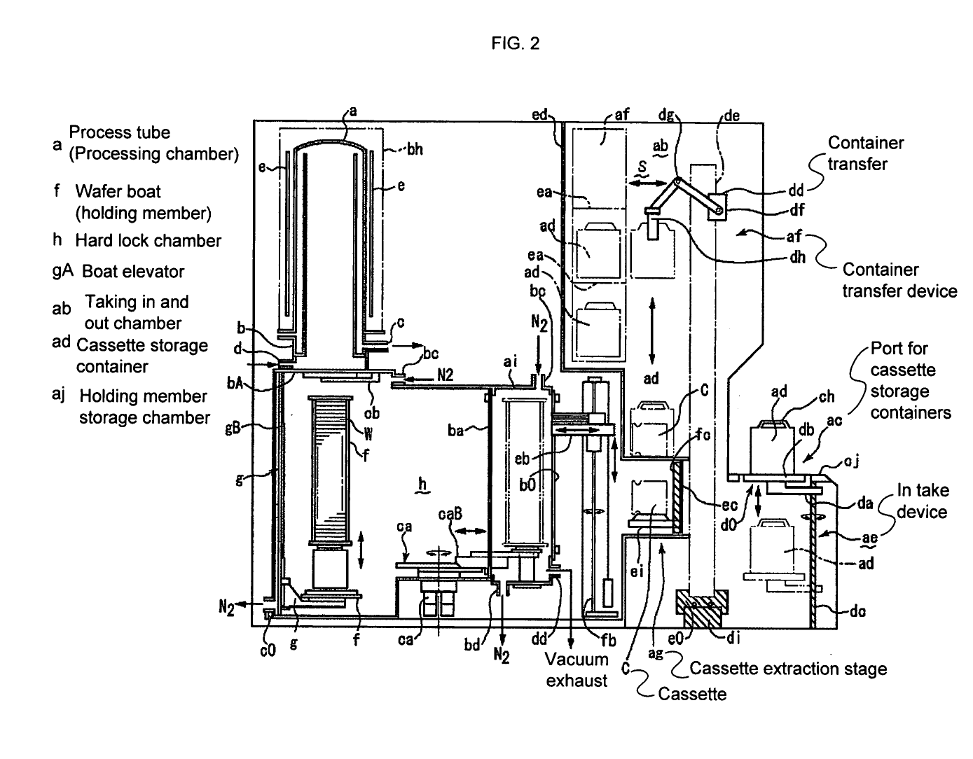

The manufacturing apparatus 11 is an apparatus for performing the prescribed process to a substrate to be processed, for example, a semiconductor wafer. The manufacturing apparatus 11, for example, performs the various processes to substrates to be processed, such as a film forming process, an etching process and a thermal oxidation process. The manufacturing apparatus 11 is, for example, a batch system vertical type thermal treatment equipment in the above-mentioned Unexamined Japanese Patent Application Publication No. 2006-216,920 (the 1st page, FIG. 1), or Japanese Patent No. 3,543,996 (the 1st page, FIG. 1). The example of this manufacturing apparatus 11 is shown in FIG. 2. This manufacturing apparatus 11 is an apparatus formed into what is called load-lock-chamber configuration that was designed to be sealed to other chambers as a loading room, and was designed so that N2 gas as inactive atmosphere can be supplied or can be evacuated. The manufacturing apparatus 11 is configured by a process tube “a”, which is a process chamber for performing a prescribed process to a wafer W being a member to be processed, a load-lock-chamber “h” as a loading chamber equipped with a transport mechanism “g” for inserting or extracting a wafer boat “f” as a holding member, which stores a plurality of wafers, for example, 100 wafers against the process tube “a”, a taking in and out chamber “ab”, which conveys a wafer in and out from this load-lock-chamber “h”, a port for cassette storage containers “ac” formed in this taking in and out chamber “ab”, an intake device “ae” for taking in a cassette storage container “ad” placed on this port “ac” in the taking in and out chamber “ab”, a container holding stage “af”, which temporarily keeps the taken-in cassette storage container “ad”, a cassette extraction stage “ag”, which takes out the cassette “C” stored in the cassette storage container “ad”, a container transfer member “ah”, which transfer the cassette storage container “ad” within the taking in and out chamber “ab”, and a holding member storage chamber “ai” for storing a wafer boat “f” disposed between the load-lock-chamber “h” and the taking in an out chamber “ab”. In addition, with respect to the other parts and operations in the example of the manufacturing apparatus 11 of FIG. 2, since it is a well-known technique (refer to Japanese Patent No. 3543996 (on the 1st page, FIG. 1)), detailed description will be omitted. In addition, with respect to the chamber, which forms the manufacturing apparatus 11, a chamber disclosed in FIG. 1 of the Unexamined Japanese Patent Application Publication No. 2002-25997 is suitable. In addition, in this embodiment, there is no specific restriction for configuration of not less than one manufacturing apparatuses. The manufacturing apparatuses from manufacturing apparatus 11a to 11n may include manufacturing apparatuses, which perform a different process, and perform the same process.

In addition, the manufacturing apparatus 11, for example, stores the recipe, which is the information of the prescribed process for the wafer, and controls it using the recipe.

In addition, a server apparatus 12 is a server apparatus, which forms what is called a group management system, capable of storing the information including various kinds of measurement information transmitted from not less than one manufacturing apparatus 11, and has the function to perform abnormal detection to the measurement information.

In addition, the client apparatus 13 receives process results, such as abnormal detection transmitted from the server apparatus 12. In addition, the client apparatus 13 transmits various kinds of requests to the server apparatus 12.

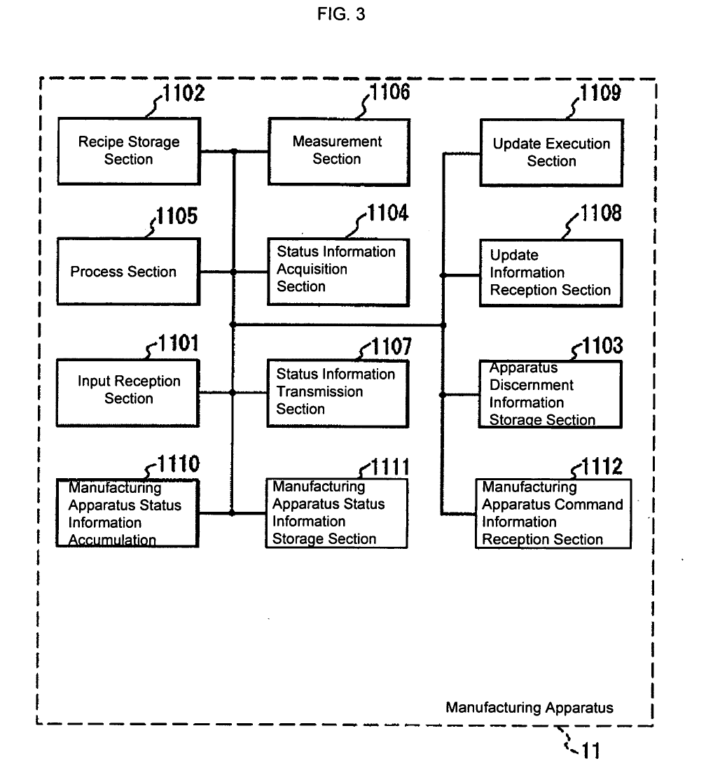

FIG. 3 illustrates a block diagram of the manufacturing apparatus of the group management system in the embodiment of the present invention. In addition, here, the case where the number of the manufacturing apparatus 11, is one is shown for convenience of explanation.

The manufacturing apparatus 11 includes an input reception section 1101, a recipe storage section 1102, an apparatus discernment information storage section 1103, a status information acquisition section 1104, a process section 1105, a measurement section 1106, a status information transmission section 1107, an update information reception section 1108, an update execution section 1109, a manufacturing apparatus status information accumulation section 1110, a manufacturing apparatus status information storage section 1111 and a manufacturing apparatus command information reception section 1112.

The input reception section 1101 receives various kinds of inputs from the user of the manufacturing apparatus 11. The various kinds of inputs, for example, are execution instructions of processes, such as a recipe and processing treatment to wafer. The various kinds of input means of input from the user may be any kinds of input means, such as a ten key, a keyboard, a mouse, or menu panel. The input reception section 1101 can be realized by a device driver of the input means of a ten key and a keyboard, and the control software of menu screen.

The recipe storage section 1102 stores the recipe used in order to control the manufacturing apparatus 11. A recipe denotes information of the prescribed process, which manufacturing apparatus 11 executes, and usually the information, which sets up a plurality of procedures, which form a process, and the process parameter in the procedure therein, is included. The information of the process parameter includes, for example, a category name, an item name, a parameter name, and a value. The category name denotes a name, which shows the kind of process parameter, for example, “temperature”, “gas mass flow amount”, and “the speed of a boat elevator”. The item name is a name, which shows the attribute of a process parameter, for example, “up-and-down speed” and “revolving speed”. The parameter name is a name of a process parameter, for example, “C” and “A”. The value is a value given to a variable called a process parameter. Usually, the recipe is stored in paired with a recipe identifier (for example, recipe name), which identifies the recipe. Although a nonvolatile recording medium is preferable for the recipe storage section 1102, it can also be realizable by a volatile recording medium.

The apparatus discernment information storage section 1103 stores the apparatus discernment information for identifying the manufacturing apparatus 11. The apparatus discernment information may be information, which can identify each manufacturing apparatus 11, for example, may be an identification number and a name, which were set as a device name, a part number, a serial number and each manufacturing apparatus 11. The information, which input reception section 1101 received, and the information stored in advance at the time of manufacturing apparatus shipment may be sufficient as this apparatus discernment information. A volatile recording media, such as RAM, and also the nonvolatile recording medium, such as a hard disk and a ROM, may be sufficient as the apparatus discernment information storage section 1103.

The status information acquisition section 1104 acquires the status information, which is information on the time series of the status of the manufacturing apparatus 11, which is a self-apparatus. Concretely, the information on the time series of a status is the information relevant to a utilization status of the manufacturing apparatus acquired in accordance with the time series, and information relevant to an operation status of the manufacturing apparatus. The information relevant to the utilization status, for example, is information showing the kinds of the process and the control, which have been started, under execution or ended by the manufacturing apparatus, and the information of parameters, such as a setting value when the manufacturing apparatus controls. The information relevant to a utilization status is information, which shows like what kind of instructions and demand the manufacturing apparatus received, and what kind of recipe is under execution on what kind of step. What is called a log is included in the status information relevant to such utilization status. The information relevant to the operation status of manufacturing apparatus is, for example, measurement information, which was measured at the time of the operation of the manufacturing apparatus, such as the temperature and the pressure in the manufacturing apparatus, the electric power supplied to the manufacturing apparatus, and a flow of material gas. For example, the status information acquisition section 1104 acquires the information, which shows the utilization status of the manufacturing apparatus 11, which is one of the status information, from the process section 1105, which will be described later. The status information acquisition section 1104 acquires, for example, the measurement information, which is one of the status information, from a measurement section 1106, which will be described later. The status information usually includes the time information being the information showing the time of the information being formed and the time of the information showing the utilization status and the measurement information configuring the status information being acquired. However, the time information may be omitted. For example, the status information is information added so that the time information, which shows the time when this information was acquired, might serve as a pair to the information showing the utilization status of the manufacturing apparatus, such as the start and the end of various processes. The status information, for example, is information added so that the time information, which shows the time that the measurement information was acquired, might serve as a pair to the measurement information of the temperature and the pressure. For example, the status information acquisition section 1104 may be arranged to acquire the information configured by adding the time information to the measurement information and information showing the utilization status of the process section 1105 and the measurement section 1106 as the status information. The status information acquisition section 1104 may configure the status information by adding the time information to the information showing the utilization status acquired from the process section 1105 and the measurement section 1106, and the measurement information. As an example, the status information acquisition section 1104 adds the information on the measured time to the measurement information acquired by the measurement section 1106, and obtains the status information. For example, the status information acquisition section 1104 acquires the information of the process executed when the process section 1105 performs a prescribed process, for example, the name of the process, the recipe name to be executed and the parameter of the process, from the process section 1105. The status information acquisition section 1104 adds the time information being the information of the time, which has acquired this information, and obtains the status information. This time information is acquired, for example, from the clock not illustrated. The status information acquisition section 1104 may add the information, which shows the data type of the measurement information included in status information, and the information showing the utilization status of the manufacturing apparatus 11, namely, the kind of data, to the status information. The information showing the data type, as example, may denote the information showing the kind of measurement information, such as “temperature” and “pressure”, or may denote the information showing that the information is related to the utilization status, for example, such as a “log”. The status information acquisition section 1104 may temporarily accumulate the acquired status information to the recording medium, such as the memory, or may output the acquired status information to a status information transmission section 1107 mentioned later without accumulating. The status information acquisition section 1104 may usually be realized by the MPU and the memory. The processing procedure of the status information acquisition section 1104 is usually realized by software, and the software is recorded on a recording media, such as the ROM. However, the processing procedure of the status information acquisition section 1104 may be realized by the hardware (dedicated circuit).

The process section 1105 reads out the recipe in the recipe storage section 1102, and performs the prescribed process against the substrate to be processed according to the recipe. Here, as an example, the process section 1105 constantly outputs the information of the utilization status of manufacturing apparatus 11, concretely, the information identifying the process of the instructions and the process name at the time of performing a desired process, and the information regarding the parameter to the status information acquisition section 1104. The process section 1105 may be designed so as to add the time information showing the time of the acquisition of this information to the information of the utilization status of the manufacturing apparatus 11. Such time information is acquired from the clock, which is not illustrated. Instead of outputting the information mentioned above at all times, the process section 1105 may temporarily store the above mentioned information to the recording media, such as the memory, and the acquisition section 1104 may be arranged to summarize and acquire this stored information later. The process section 1105 executes the process corresponding to the command included in the manufacturing apparatus command information received by the manufacturing apparatus command information reception section 1112. For example, when the commands included in the manufacturing apparatus command information are the instructions for transmitting desired status information to a prescribed client apparatus 13, the process section 1105 acquires the desired status information stored in the manufacturing apparatus status information storage section 1111. And the acquired status information is transmitted to the server apparatus 12 from the status information transmission section 1107. When the commands included in the manufacturing apparatus command information are the instructions for stopping the process, which manufacturing apparatus 11 is executing, the process section 1105 stops the process, which the manufacturing apparatus 11 is executing, corresponding to this command. The process section 1105 may usually be realized by the MPU and the memory. The processing procedure of the process section 1105 is usually realized by software, and the software is recorded on the recording media, such as the ROM. However, the processing procedure of the process section 1105 may be realized by hardware (dedicated circuit).

The measurement section 1106 acquires the measurement information being the information of the result of having performed the measurement of the temperature in the manufacturing apparatus 11, a gas flow amount, pressure and the electric power of the manufacturing apparatus 11. The measurement information is information of the measured temperature. The measurement section 1106, for example, conducts the measurements at regular intervals or an irregular prescribed time interval. In addition, the measurement section 1106 shall output measurement information to status information acquisition section 1104 as required as an example here. The measurement section 1106 may be arranged to add time information to such measurement information. Such time information is acquired from the clock, which is not illustrated. In addition, the measurement section 1106 may temporarily store the measurement information to the recording media, such as the memory, instead of outputting the measurement information all the time, and the acquisition section 1104 may be arranged to summarize and acquire this stored information later. In addition, the measurement information may have the information for identifying a measuring object, for example, temperature and gas pressure, and a measurement point, for example, inside of the process tube, which the measurement section 1106 measures, for example, the name of a measuring object, a name of a measurement point, or the discernment information corresponding to these. It is apparent that the measurement section 1106 may measure a plurality of temperature of a plurality of points, and a plurality of values, such as a gas flow amount and temperature. Namely, original information may have two or more kinds of measured values. The measurement section 1106 may be realized by sensors, such as not less than one temperature sensors and not less than one flow rate sensors.

The status information transmission section 1107 transmits not less than one status information, which the status information acquisition section 1104 acquired. Here, as an example, the status information transmission section 1107 correlates the apparatus discernment information of the manufacturing apparatus 11, which is a self-apparatus, with the acquired status information, and transmits it. However, when the manufacturing apparatus 11 from which the status information has been transmitted can be specified in the reception side of the status information, it is not necessary to correlate the apparatus discernment information with the status information to transmit it. In addition, the status information acquisition section 1104 mentioned above may add apparatus discernment information to the status information. This apparatus discernment information is acquired, for example, from the apparatus discernment information storage section 1103. The status information transmission section 1107 is able to transmit not less than one kind of the status information. The status information transmission section 1107 is able to transmit, for example, the status information being the measurement information of the temperature, and the status information being the information showing the name of the process, which the manufacturing apparatus 11 is executing. Here, as an example, the status information transmission section 1107 transmits the status information to the server apparatus 12. It is preferable that every time when the status information acquisition section 1104 acquires the status information, the status information transmission section 1107 transmits not less than one status information, which the status information acquisition section 1104 has acquired, in order to perform a process in real time. However, the status information summarizing only a prescribed number of the information (for example, the status information to which ten pieces of information has been summarized) may be transmitted at once. For example, the status information acquisition section 1104 once accumulates the acquired status information to the memory, and the status information transmission section 1107 may collectively read out and transmit the accumulated status information. In addition, there is no specific restriction for timing or trigger, which transmit the status information in this case. And, the status information transmission section 1107 may be allowed to read out and transmit the status information corresponding to a prescribed timing at regular or irregular intervals, and a prescribed trigger. In addition, corresponding to the manufacturing apparatus command information, which the manufacturing apparatus command information reception section 1112 received, the desired status information acquired by the process section 1105 may be transmitted to the server apparatus 12. In addition, new status information obtained by performing the prescribed process of a statistical process to a plurality of status information may be transmitted. In addition, when the status information transmission section 1107 outputs the status information, the status information transmission section 1107 acquires the time information showing the present time from the clock, adds the time information to the status information, and transmits the status information. There is no specific restriction for unit and data structure, which the status information transmission section 1107 transmits. The status information transmission section 1107 is realized by the communication means of wireless or a cable.

The update information reception section 1108 receives the update information, which is the information for updating the manufacturing apparatus 11. The update information is, concretely, a program for updating the software, which performs the process of the manufacturing apparatus 11, what is called a patch, the setting information that is referred when the manufacturing apparatus 11 performs the process, and a program for updating information, such as parameter. There is no specific restriction for data structure of the update information. The update information reception section 1108 may accumulate the received update information in the storage medium, such as the hard disk, which is not illustrated. The update information reception section 1108 is realized by the means of communication of the wireless or the cable.

The update execution section 1109 performs update of the manufacturing apparatus 11 using the update information received by the update information reception section 1108. In case when the update information is accumulated in the storage medium by the update information reception section 1108, the update execution section 1109 updates by reading this update information. For example, a program, setting information and parameter information in the manufacturing apparatus 11 corresponding to the update information are updated. There is no specific restriction for a trigger for the update execution section 1109 to perform update. The update may be performed at the time when the update information reception section 1108 receives the update information or next time when the manufacturing apparatus 11 is started. In addition, since the structure for performing the update of the program using the update information is a well-known technique, detailed description is omitted here. The update execution section 1109 may usually be realized from a MPU or a memory. The processing procedure of the update execution section 1109 is usually realized by software, and the software is recorded on recording medium, such as a ROM. However, the processing procedure of the update execution section 1109 may be realized by hardware (dedicated circuit).

The manufacturing apparatus status information accumulation section 1110 accumulates not less than one status information acquired by the status information acquisition section 1104 to the manufacturing apparatus status information storage section 1111 described later. The manufacturing apparatus status information accumulation section 1110 is usually realized by the MPU or the memory. The processing procedure of the manufacturing apparatus status information accumulation section 1110 is usually realized by the software, and the software is recorded on recording medium, such as the ROM. However, the processing procedure of the manufacturing apparatus status information accumulation section 1110 may be realized by the hardware (dedicated circuit).

Not less than one status information acquired by the status information acquisition section 1104 is stored in the manufacturing apparatus status information storage section 1111. The manufacturing apparatus status information storage section 1111 may be a volatile recording medium, such as a RAM or a non-volatile recording medium, such as a hard disk and the ROM.

The manufacturing apparatus command information reception section 1112 receives the manufacturing apparatus command information transmitted from the server apparatus 12. The manufacturing apparatus command information is described later. The manufacturing apparatus command information reception section 1112 is realized by a communication means of the wireless or the cable.

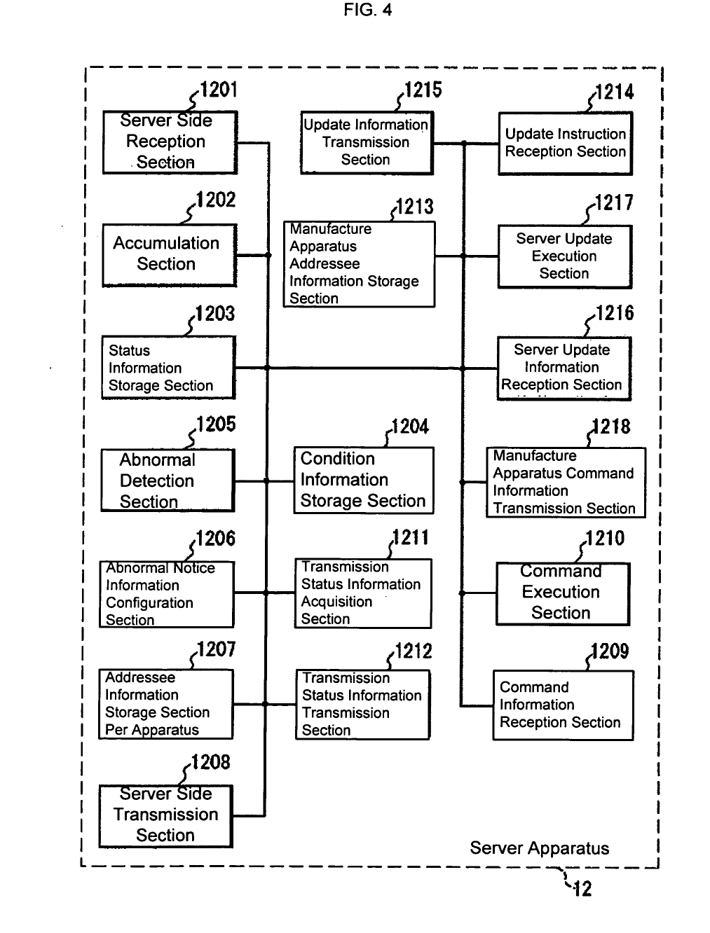

FIG. 4 illustrates a block diagram of the server apparatus of the group management system of an embodiment of the present invention.

The server apparatus 12 includes a server side reception section 1201, an accumulation section 1202, a status information storage section 1203, a condition information storage section 1204, an abnormal detection section 1205, an abnormal notice information configuration section 1206, an addressee information per apparatus storage section 1207, a server side transmission section 1208, a command information reception section 1209, a command execution section 1210, a transmission status information acquisition section 1211, a transmission status information transmission section 1212, a manufacturing apparatus addressee information storage section 1213, an update instruction reception section 1214, an update information transmission section 1215, a server update information reception section 1216, a server update execution section 1217 and a manufacturing apparatus command information transmission section 1218.

The server side reception section 1201 receives the status information from not less than one manufacturing apparatus 11. In addition, the apparatus discernment information correlated with the status information may also be received. The server side reception section 1201 may be realized by the communication method of the wireless or the cable.

The accumulation section 1202 correlates the status information received by the server side reception section 1201 with the apparatus discernment information corresponding to the status information and accumulates the correlated information to the status information storage section 1203, which will be described later. The apparatus discernment information corresponding to the status information, here, for an example, is the apparatus discernment information correlated with the status information received by the server side reception section 1201. In addition, in a case where the apparatus discernment information correlated with the status information is not transmitted from the manufacturing apparatus 11, for example, the manufacturing apparatus 11 from which the status information has been transmitted is specified from the address information on the network transmitted with the status information and/or from the input terminal into which the status information is inputted. The accumulation section 1202 may be arranged to correlate the apparatus discernment information corresponding to the manufacturing apparatus 11 with the status information and accumulate the correlated information to the status information storage section 1203. The status information and the apparatus discernment information corresponding to this, for example, are controlled as two attributes of the same record. The accumulation section 1202 is usually realized from the MPU or the memory. The processing procedure of the accumulation section 1202 is usually realized by software, and the software is recorded on the recording medium, such as the ROM. However, the processing procedure of the accumulation section 1202 may be realized by hardware (dedicated circuit).

The status information received by the server side reception section 1201 and the apparatus discernment information corresponding to the status is stored in the status information storage section 1203. The status information storage section 1203 may be volatile recording medium, such as a RAM, or non-volatile recording medium, such as a hard disk and a ROM.

The condition information storage section 1204 stores condition information being the information relating to a condition of the abnormal detection. The condition information, for example, is an upper limit and a lower limit showing a normal range of measurement value. The condition information, for example, may only be the boundary value between a normal value and an abnormal value. In addition, the condition information differs by target data types of measurement (temperature, a pressure, a gas mass flow, and electric power) and a recipe performed. In addition, there is no specific restriction for the configuration of the condition information. Although the non-volatile recording medium is suitable for the condition information storage section 1204, it is also realizable with the volatile recording medium.

The abnormal detection section 1205 detects the occurrence of the abnormality of not less than one manufacturing apparatus 11 using at least a part of the status information received by the server side reception section 1201. Specifically, the abnormal detection section 1205 determines the abnormality by acquiring the condition information from the condition information storage section 1204, and determining whether or not a part of the status information received by the server side reception section 1201 matches to the condition information. A part of the status information, for example, denotes measurement information, such as the temperature and the pressure in the manufacturing apparatus 11, a gas mass flow and power supply. For example, the abnormal detection section 1205 determines whether the measurement information, which is specified in advance and is a part of the status information received by the server side reception section 1201, matches the condition information acquired from the condition information storage section 1204 according to the recipe and processing step under execution. Then, when the condition information is the condition information indicating the occurrence of the abnormality, and in case when the measurement information specified in advance matches the condition, the abnormal detection section 1205 detects the occurrence of the abnormality in the manufacturing apparatus 11 corresponding to this condition information. Specifically, the occurrence of the abnormality in the manufacturing apparatus 11 corresponding to the apparatus discernment information correlated with the condition information showing the abnormal value is detected. The status information used for detecting this abnormality, namely, the measurement information, may be the measurement information of any target, such as the temperature and the pressure in the manufacturing apparatus 11, the gas mass flow and the power supply. In addition, the measurement information to become the target of the determination may be plural. In addition, the status information used for detecting the abnormality is not limited to the measurement information. The status information may be the information regarding the utilization status of the apparatus, such as the log. The abnormal detection section 1205 may perform the abnormal detection process mentioned above by directly acquiring the status information received by the server side reception section 1201, or may perform the abnormal detection process mentioned above to the status information stored in the status information storage section 1203. The abnormal detection section 1205 is usually realized by the MPU or the memory. The processing procedure of the abnormal detection section 1205 is usually realized by the software recorded on the recording medium, such as the ROM. However, the processing procedure of the abnormal detection section 1205 may be realized by the hardware (dedicated circuit). In addition, the abnormal detection processing in the abnormal detection section 1205 may be a well-known abnormal detection process.

The abnormal notice information configuration section 1206 configures abnormal notice information, which is the information having not less than one apparatus discernment information corresponding to not less than one manufacturing apparatus 11 in which the abnormality has occurred, and the information for notifying the occurrence of the abnormality when the abnormal detection section 1205 detects the occurrence of the abnormality in any one of not less than one manufacturing apparatus 11. Specifically, the abnormal notice information configuration section 1206 acquires the apparatus discernment information correlated to the status information from which the abnormal detection section 1205 has detected the abnormality from the server side reception section 1201 or the status information storage section 1203, and the abnormal notice information configuration section 1206 configures the abnormal notice information including the acquired apparatus discernment information. When the abnormal detection section 1201 detects the abnormality in a plurality of the manufacturing apparatus 11 simultaneously, or within a fixed or unfixed predetermined period, it is suitable for the abnormal notice information configuration section 1206 to configure one abnormal notice information including the apparatus discernment information of a plurality of the manufacturing apparatus 11 in which the abnormality has been detected. In this way, as described later, when the command information is transmitted by a reply e-mail to this abnormal notice information, it becomes possible to execute the command regarding a plurality of the manufacturing apparatuses 11 in which the abnormality has been detected at once. Therefore, the speed up of the process can be attained since the time and effort of a user transmitting the command information to each manufacturing apparatus can be saved. In order to configure this way, for example, when the abnormality was newly detected in other manufacturing apparatus 11 with in the predetermined period set in advance after the above-mentioned abnormal detection section 1205 detects the abnormality in one manufacturing apparatus 11, the abnormal notice information may be arranged to be configured so as to include the apparatus discernment information of the manufacturing apparatus 11 in which the abnormality was newly detected. In addition, the abnormal notice information of a plurality of the manufacturing apparatus in which the abnormality has been detected may be configured so that the abnormal notice information having the same addressee may become one abnormal notice information. For example, the addressee information corresponding to the apparatus discernment information of a plurality of the manufacturing apparatus in which the abnormality has been detected is acquired by utilizing the addressee information per apparatus stored in the addressee information per apparatus storage section 1207, which will be described later. The abnormal notice information including the apparatus discernment information of not less than one manufacturing apparatus matching to this addressee information may be arranged to configure each addressee. In addition, in case when the abnormalities have been detected in a plurality of the manufacturing apparatus 11 simultaneously or within a predetermined period, the abnormal notice information of each manufacturing apparatus 11 may be individually created. It is preferable for the abnormal notice information to include the apparatus discernment information so that the apparatus discernment information may be eventually displayed on a client apparatus 13. This is because it becomes possible to notify a user of the apparatus in which the abnormality has occurred. However, the apparatus discernment information may be included in a non-display portion. For example, when the abnormal notice information is transmitted as E-mail, the apparatus discernment information may be disposed onto the header, which usually is not displayed. The abnormal notice information configured by the abnormal notice information configuration section 1206, for example, is image information showing the occurrence of the abnormality or text information, such as “the abnormality has occurred in apparatus ABC” assuming that the apparatus discernment information was the “apparatus ABC”. However, the apparatus discernment information included in the abnormal notice information is arranged to be included in the abnormal notice information in a state to be able to recognize, for example, search as the apparatus discernment information. In addition, the apparatus discernment information may be replaced or partly changed as long as correspondence relationship with the manufacturing apparatus 11 is maintained. For example, the apparatus discernment information called “E2” corresponding to the manufacturing apparatus 11b may be converted into “CVD apparatus No. 1”, which is a title of the manufacturing apparatus 11b, by utilizing the conversion table prepared in the memory in advance. In addition, in an embodiment of the present invention, also in such case, it will be treated as the same apparatus discernment information. The abnormal notice information configuration section 1206, for example, configures the abnormal notice information by disposing the apparatus discernment information in a position to dispose the apparatus discernment information in a template prepared in advance. Specifically, the template of the abnormal notice information having text information of “The abnormality has occurred in <the apparatus discernment information>” is prepared, and by replacing the sample sentence of “<the apparatus discernment information>” of this text with a sample sentence of “apparatus ABC” being the apparatus discernment information of the manufacturing apparatus in which the abnormality has been detected, the abnormal notice information is configured as “The abnormality has occurred in the apparatus ABC”. In addition, the template, which has a text or an image notifying of the abnormality, such as “abnormality has occurred in the apparatus” is prepared in advance. Then, the apparatus discernment information may be disposed on the title of this text or the image. The abnormal notice information configuration section 1206 is usually realized by the MPU or the memory. The processing procedure of the abnormal notice information configuration section 1206 is usually realized by the software, and the software is recorded on the recording medium, such as the ROM. However, the processing procedure of the abnormal notice information configuration section 1206 may be realized by the hardware (dedicated circuit).

The addressee information per apparatus, which is the information including the apparatus discernment information and the addressee information being the addressee information of the client apparatus 13 corresponding to the apparatus discernment information, is stored in the addressee information per apparatus storage section 1207. The addressee information is the information that is capable of specifying an addressee. For example, the addressee information is the address information on the network of the client apparatus 13 serving as an addressee, or e-mail address of the client apparatus 13. The addressee information per apparatus, for example, is the information, which has the apparatus discernment information and addressee information corresponding to the apparatus discernment information on each record. In the addressee information per apparatus, the correspondence relationship between the apparatus discernment information and the addressee information may be 1 to 1, and may be 1 to plurality. Although a non-volatile recording medium is suitable for the addressee information per apparatus storage section 1207, it is realizable with a volatile recording medium.

The server side transmission section 1208 transmits the abnormal notice information to a predetermined client apparatuses 13. The predetermined client apparatuses 13 may be all the client apparatuses 13, or may be a few of the client apparatuses 13. The addressee information specifying an addressee, for example, is accumulated in the storage medium, such as a hard disk not illustrated, in advance. The server side transmission section 1208 reads this addressee information at the time of transmission, and transmits the abnormal notice information acquired from the abnormal notice information configuration section 1206 to the addressee shown by this addressee information. Especially here, the server side transmission section 1208 acquires the addressee information corresponding to the apparatus discernment information of the manufacturing apparatus 11, in which the abnormality has occurred, according to the addressee information per apparatus stored in the addressee information per apparatus storage section 1207. The server side transmission section 1208 transmits the abnormal notice information to the addressee shown by this addressee information using the acquired addressee information. For example, the server side transmission section 1208 acquires the apparatus discernment information correlated with the status information, in which the abnormal detection section 1205 has detected the abnormality, from the server side reception section 1201, the status information storage section 1203, or the abnormal notice information configuration section 1206. And, the apparatus discernment information, which matches with this acquired apparatus discernment information, is searched within the addressee information per apparatus stored in the addressee information per apparatus storage section 1207. Then, not less than one addressee information correlated with the matching apparatus discernment information is acquired from the addressee information per apparatus. This match may be an exact match or may be a partial match. And, the abnormal notice information is transmitted to the client apparatus 13, which is an addressee shown by this addressee information. In addition, when a plurality of apparatus discernment information is included in one abnormal notice information, the abnormal notice information may be transmitted to all the addressees shown by the addressee information corresponding to each apparatus discernment information, or the abnormal notice information may be transmitted only to a common addressee within the addressees shown by the addressee information corresponding to all the apparatus discernment information. The server side transmission section 1208 may be arranged to transmit the abnormal notice information using an electronic mail. In this case, the electronic mail having the abnormal notice information as a text may be transmitted, or the electronic mail having the abnormal notice information as an attached file may be transmitted. In addition, the electronic mail may be a rich text mail or a text mail of a HTML MAIL. The server side transmission section 1208 may be realized by the communication method of wireless or a cable. In addition, the server side transmission section 1208 may have the MPU or the memory in order to perform the process for acquiring the addressee. The processing procedure for acquiring this addressee is usually realized by the software, and the software is recorded on recording medium, such as the ROM.

The command information reception section 1209 receives the command information transmitted from the client apparatus 13. For example, this command information is the information transmitted from the client apparatus 13 using the electronic mail. The command information is the information including the command for the manufacturing apparatus 11 in which the abnormality has occurred to perform an execution, and the apparatus discernment information including the above-mentioned abnormal notice information. Specifically, the command included in this command information is a command for the manufacturing apparatus 11 corresponding to the apparatus discernment information included in the command information to perform the execution. However, the information specifying the manufacturing apparatus 11 does not need to be included in the command itself included in the command information. The command for the manufacturing apparatus 11 to perform the execution may be the command for instructing the server apparatus 12 to perform the process to the manufacturing apparatus 11, and the command for the server apparatus 12 to perform a predetermined process regarding the information corresponding to the manufacturing apparatus 11 of the information stored in the status information storage section 1203. For example, the command for the server apparatus 12 to output desired status information within the status information of the manufacturing apparatus 11. In addition, the command included in the command information may be a command for updating the manufacturing apparatus 11 corresponding to the apparatus discernment information. In addition, the command included in the command information may be a command for the manufacturing apparatus 11 corresponding to the apparatus discernment information to perform the predetermined process. Specifically, it may be a command for the manufacturing apparatus to output desired status information within the status information accumulated in the manufacturing apparatus 11, or may be a command to stop or reset the manufacturing apparatus 11. In addition, an explicit command, for example, a command, may not be included within the command information. For example, when the command information including the apparatus discernment information is received, it may be considered that the command information reception section 1209 has received the command information including the command for acquiring the desired status information regarding the manufacturing apparatus corresponding to this apparatus discernment information. The command information reception section 1209 is realized by the communication method of a cable or wireless.

The command execution section 1210 executes the command included in the command information received by the command information reception section 1209. Specifically, the command execution section 1210 executes the command included in this command information using the apparatus discernment information included in the command information received by the command information reception section 1209. Especially, in an embodiment of the present invention, when the command information received by the command information reception section 1209 includes the command to be executed by the server apparatus 12, the command execution section 1210 executes the command included in the command information. Specifically, the command execution section 1210 executes the command included in the command information. The command execution section 1210 outputs the instruction according to the command, and controls other process sections. This command, for example, as mentioned above, is a command executed to the manufacturing apparatus 11 corresponding to the apparatus discernment information included in the command information. For example, by having the command execution section 1210 perform the command, an instruction is given to the transmission status information transmission section 1212 which will be described later, and the status information corresponding to the apparatus discernment information is acquired, for example, by using the apparatus discernment information as a key for searching. In addition, in case when the command included in the command information received by the command information reception section 1209, for example, is a command given to the manufacturing apparatus 11 in which the abnormality has occurred, the command execution section 1210 configures the manufacturing apparatus command information, which is the command information corresponding to the received command information, and transmits this manufacturing apparatus command information to the manufacturing apparatus 11 in which the abnormality has occurred. Specifically, the command information reception section 1209 configures the manufacturing apparatus command information corresponding to the command included in the command information received by the command information reception section 1209. And, the information of an addressee on the manufacturing apparatus 11 in which the abnormality has occurred, for example, an IP address or an e-mail address is acquired from a table showing the correspondence relationship between the apparatus discernment information prepared in advance and the information of the addressee of the manufacturing apparatus 11, here, specifically, which is acquired from the manufacturing apparatus addressee information stored in the manufacturing apparatus addressee information storage section 1213, which will be described later by using the apparatus discernment information included in the command information received by the command information reception section 1209 as a search key. The instruction for transmitting the configured manufacturing apparatus command information to this addressee is given to the manufacturing apparatus information transmission section 1218, which will be described later. The command included in the manufacturing apparatus command information is a command corresponding to the command included in the command information received by the command information reception section 1209, and it only needs to be a command for the manufacturing apparatus 11 to be able to execute, and it may be exactly the same as the command included in the command information received by the command information reception section 1209, or the command included in this received command information may be a command converted into the command for the manufacturing apparatus 11. In addition, there is no specific restriction for data structure as long as the manufacturing apparatus command information is the information including such command and the information may be any kind. The manufacturing apparatus command information may also include the information for specifying addressees, such as the e-mail address and the IP address of the client apparatus from which the command information received by the command information reception section 1209 is transmitted. The apparatus discernment information of the manufacturing apparatus 11 in which the abnormality has occurred may or may not be included. In addition, the manufacturing apparatus command information may be the same as the command information received by the command information reception section 1209, and the manufacturing apparatus command information may be the information capable of being transmitted by e-mail. In addition, in case when the explicit command, for example, such as the command, is not included within the command information, the command stored in the storage medium, such as the memory, in advance, for example, may be arranged to be read and executed according to the received command information. For example, when the command information reception section 1209 has received the command information including the apparatus discernment information, the command execution section 1210 reads the command, which acquires the desired status information regarding the manufacturing apparatus corresponding to this apparatus discernment information, from the memory, and the command execution section 1210 controls the other process section by outputting various instructions to acquire the desired status information regarding the manufacturing apparatus 11 corresponding to the apparatus discernment information included in the command information. The command execution section 1210 may usually be realized by the MPU and the memory. The processing procedure of the command execution section 1210 is usually realized by the software, and the software is recorded on the recording medium, such as the ROM. However, the processing procedure of the command execution section 1210 may be realized by the hardware (dedicated circuit).

The transmission status information acquisition section 1211 acquires at least a part of the status information correlated with the apparatus discernment information included in the command information according to the instruction of the command execution section 1210 and stored in the status information storage section 1203. The transmission status information acquisition section 1211 configures the transmission status information, which is the status information for transmission. The transmission status information acquisition section 1211, for example, searches the apparatus discernment information, which matches with the apparatus discernment information included in the command information, within the status information storage section 1203, and acquires at least a part of the apparatus discernment information corresponding to this matching apparatus discernment information. At least a part of the status information, for example, is not less than one of a plurality of the status information, the data types of which have been described above, are different. Specifically, a part of the status information, for example, may only be the log of the status information, may only be the measurement information of the temperature, and may be the combination of the measurement information on the temperature, the measurement information on a gas mass flow, and the log. In addition, it may also be all of the status information. In addition, at least a part of the status information may be the information within a predetermined time zone of these status information. For example, it may be the information from one hour before the the time of the occurrence of the abnormality till the occurrence of the abnormality. There is no specific restriction for as to how at least a part of the status information is set. For example, as a parameter of the command, the information for setting up at least a part of such status information may be included in the command information, and may be accumulated in the recording medium, such as a memory, which is not illustrated, in advance. The transmission status information acquisition section 1211 acquires the status information according to the information for setting up at least a part of this status information according to the instruction of the command execution section 1210, and configures the transmission status information. The transmission status information acquisition section 1211 may include the apparatus discernment information corresponding to this transmission status information within the transmission status information. In addition, the transmission status information acquisition section 1211 may acquire the desired status information of the manufacturing apparatus 11 from which the abnormality has been detected, which has been received by the server side reception section 1201 corresponding to the manufacturing apparatus command information transmitted by the manufacturing apparatus command information transmission section 1218, and may configure the transmission status information. There is no specific restriction for the data structure and the file format of the transmission status information configured by the transmission status information acquisition section 1211. For example, the transmission status information acquisition 1211 may configure the transmission status information in the file format of a text format, a format capable of being read by spreadsheet software, or, for example, a CSV format capable of being read by a database. The transmission status information acquisition section 1211 is usually realized by the MPU and the memory. The processing procedure of the transmission status information acquisition section 1211 is usually realized by the software, and the software is recorded on the recording medium, such as the ROM. However, the processing procedure of the transmission status information acquisition section 1211 may be realized by the hardware (dedicated circuit).

The transmission status information transmission section 1212 transmits the transmission status information configured by the transmission status information acquisition section 1211 to the client apparatus from where the command information is transmitted. There is no specific restriction for how the information for setting the client apparatus, from which the command information has been transmitted as an addressee, for example, the address information, is acquired. For example, the transmission status information transmission section 1212 transmits the transmission status information to the client apparatus, from which the command information is transmitted, by acquiring the IP address (for example, IP address of FROM) of the origin of the transmission included in the header of a command information received by the command information reception section 1209, specifying this IP address as an addressee, and by transmitting the transmission information. In addition, in case when the command information has been transmitted via the electronic mail, the e-mail address from which the electronic mail has been transmitted is acquired, and the transmission status information is transmitted to the client apparatus from which the command information is transmitted by transmitting transmission status information to this e-mail address via the electronic mail. “Transmitted via an electronic mail” denotes that the transmission status information may be transmitted by disposing the transmission status information in the text of the electronic mail, and may be transmitted by attaching the transmission status information in the text format or the CSV format to the electronic mail. In addition, the transmission status information transmission section 1212 may acquire the addressee corresponding to the apparatus discernment information included in the command information received by the command information reception section 1209, as same as the above-mentioned server side transmission section 1208, using the addressee information per apparatus stored in the addressee information per apparatus storage section 1207. In addition, in case when the transmission status information configured by the transmission status information acquisition section 1211 is configured by using the status information received from the manufacturing apparatus 11 corresponding to the configured manufacturing apparatus command information using the command information received by the command information reception section 1209, the transmission status information is transmitted by specifying the client apparatus 13 from which the command information has been transmitted corresponding to this transmission status information as the addressee. The information of the addressee of the client apparatus 13, from which this command information is transmitted, is acquirable as same as mentioned above. The transmission status information transmission section 1212 may be realized by the communication method of wireless or a cable. In addition, the transmission status information transmission section 1212 may have the MPU and the memory, in order to perform the process for acquiring the addressee. The processing procedure for acquiring this addressee is usually realized by the software, and the software is recorded on the recording medium, such as the ROM.

The manufacturing apparatus addressee information storage section 1213 stores the manufacturing apparatus addressee information, which is the information that includes the apparatus discernment information and the addressee apparatus information being the information of the addressee of the manufacturing apparatus 11 corresponding to the apparatus discernment information. The addressee apparatus information denotes, for example, the address information on the network of the manufacturing apparatus 11 serving as the addressee and the e-mail address of the manufacturing apparatus 11. The manufacturing apparatus addressee information, for example, is information including the apparatus discernment information and the addressee apparatus information corresponding to this on the same record. In the manufacturing apparatus addressee information, the correspondence relationship between the apparatus discernment information and the addressee apparatus information may be one to one, and may be one to a plurality. Although the non-volatile recording medium is suitable for the manufacturing apparatus addressee information storage section 1213, it is also realizable with the volatile recording medium.

The update instruction reception section 1214 receives the update instruction information transmitted from the client apparatus 13. For example, this update instruction information is the update instruction information transmitted from the client apparatus 13 using the electronic mail. The update instruction information is the information including the apparatus discernment information included in the abnormal notice information mentioned above, and the update information. The update information, for example, denotes a program used for update, a script for rewriting setting information, and a file to be added or replaced. Specifically, the update information included in this update instruction information is the update information transmitted to the manufacturing apparatus 11 corresponding to the apparatus discernment information included in the update instruction information. The update instruction reception section 1214 is realized by the communication means of the cable or the wireless.

The update information transmission section 1215 transmits the update information included in the update instruction information to the manufacturing apparatus 11 corresponding to the apparatus discernment information included in the update instruction information received by the update instruction reception section 1214. For example, when the information specifying the addressee of the manufacturing apparatus 11 corresponding to apparatus discernment information, for example, the address information of the manufacturing apparatus 11 or the e-mail address, is included in the command information, the update information transmission section 1215 transmits the update information using the information specifying this addressee. In addition, in an embodiment of the present invention, the case where the update information is transmitted to the manufacturing apparatus 11 corresponding to the apparatus discernment information is explained using the manufacturing apparatus addressee information stored in the manufacturing apparatus addressee information storage section 1213. Specifically, the apparatus discernment information congruent with the apparatus discernment information included in the update instruction information is searched from the manufacturing apparatus addressee information. The information specifying the addressee of the manufacturing apparatus 11 corresponding to the congruent apparatus discernment information is acquired. The update information is transmitted using the information specifying this addressee. The update information transmission section 1215 is realized by the communication means of the cable or the wireless.

The server update information reception section 1216 receives server update information for the server apparatus 12 to perform the update transmitted from the client apparatus 13. The server update information is a program used for the update of the server apparatus 12 a patch, and a script for rewriting the setting information. The server update information may include, other than the server update information, the command used for the update of the server apparatus 12, for example, the command for having the server perform the server update information, and the command for having the server accumulate the server update information in the desired location. In addition, the information specifying the server apparatus 12 may or may not be included. The server update information reception section 1216 may accumulate the server update information received into the memory (not illustrated). The server update information reception section 1216 is realized by the communication means of the cable or the wireless.

The server update execution section 1217 executes the server update information received by the server update information reception section 1216. The server apparatus 12 is updated by the server update execution section 1217 for executing the server update information. There is no specific restriction for the trigger or the timing for the server update execution section 1217 to update the server apparatus 12. For example, at the time of the reboot of the server apparatus 12, the server update execution section 1217 recognizes the server update information included in the server update instruction information, which the server update information reception section 1216 received and accumulated in the memory, and updates the server apparatus 12 by executing this server update information. The server update execution section 1217 may usually be realized from the MPU or the memory. The processing procedure of the server update execution section 1217 is usually realized by the software, and the software is recorded on the recording medium, such as the ROM. However, the processing procedure of the server update execution section 1217 may be realized by the hardware (dedicated circuit).

The manufacturing apparatus command information transmission section 1218 transmits the manufacturing apparatus command information configured by the command execution section 1210 using the command information received by the command information reception section 1209 to the manufacturing apparatus 11 in which the abnormality has occurred using the information of the addressee of the manufacturing apparatus 11 in which the abnormality has occurred which is inputted by the command execution section 1210. When the manufacturing apparatus command information transmission section 1218 receives the information of the addressee of a plurality of manufacturing apparatuses 11, the manufacturing apparatus command information transmission section 1218 transmits the manufacturing apparatus command information to the plurality of addressees. The command information transmission section 1218 is realized by the communication method of the cable or the wireless.

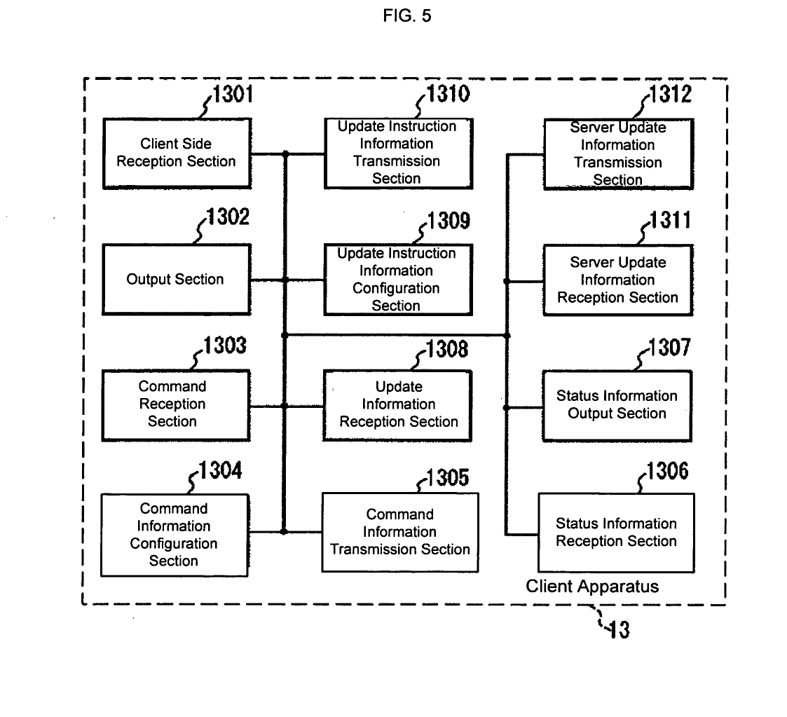

FIG. 5 illustrates a block diagram of the client apparatus of the group management system in an embodiment of the present invention. In addition, an example of when there is one of the client apparatus 13 is shown here for the convenience of the explanation.

The client apparatus 13 includes a client side reception section 1301, an output section 1302, a command reception section 1303, a command information configuration section 1304, a command information transmission section 1305, a status information reception section 1306, a status information output section 1307, an update information reception section 1308, an update instruction information configuration section 1309, an update instruction information transmission section 1310, a server update information reception section 1311, and a server update information transmission section 1312.

The client side reception section 1301 receives the abnormal notice information transmitted from the server apparatus 12. For example, the client side reception section 1301 receives the transmitted abnormal notice information using an electronic mail. The electronic mail mentioned here includes, what is called, web e-mail. The client side reception section 1301 is realized by the communication method of the cable or the wireless. In addition, in a case when the abnormal notice information is transmitted using the electronic mail, the information of the software of an electronic mail, or the memory and the MPU executing this may also be included.

The output section 1302 outputs the abnormal notice information received by the client side reception section 1301. The output mentioned here denotes a concept including the displaying to the display unit, the transmission to an external apparatus, and accumulation to a storage medium. For example, once the abnormal notice information is accumulated to the storage medium, such as a hard disk, further, this accumulated abnormal notice information may be displayed on the display corresponding to a certain trigger or instruction. The output section 1302 may be thought as to include or not include the output device, such as a display. The output section 1302 may be realized by the driver software of an output device, or the driver software of an output device, and an output device.

The command reception section 1303 receives the command to be executed on the manufacturing apparatus 11 in which the abnormality has occurred. The command to be executed on a manufacturing apparatus in which the abnormality has occurred may be a command to be executed on the server apparatus 12, and may be a command to be executed on the manufacturing apparatus 11. As a specific example, as mentioned above, the command is for the server apparatus 12 to output not less than one status information of the status information of the manufacturing apparatus 11. In addition, it may be the command to update the manufacturing apparatus 11 or the command to output not less than one status information of the status information of the manufacturing apparatus. However, here, the command received by the command reception section 1303 is the information specifying any one of the manufacturing apparatus 11, concretely it may be the information, which does not include the apparatus discernment information mentioned above. In addition, this command is not limited to the command clearly specifying an operation. For example, the transmitting of the reply e-mail of the abnormal notice information may be arranged to instruct the execution of a certain desired process to the server apparatus 12, and in this case, the reply e-mail itself serves as the command of the desired process. The reception mentioned here, for example, is a reception from the input device, the reception of input signal transmitted from the other equipment, and read-out of the information from the recording medium. The input device of the command received by the command reception section 1303 may be anything, such as a ten key, keyboard, a mouse, or a menu screen. The command reception section 1303 may be realized by the device driver of input devices, such as a ten key and a keyboard, and the control software of menu panel.

The command information configuration section 1304 configures the command information being the information including the command received by the command reception section 1303, and not less than one apparatus discernment information included in the abnormal notice information received by the client side reception section 1301. Specifically, the command information configuration section 1304 acquires the apparatus discernment information from the abnormal notice information received by the client side reception section 1301. In addition, the command information configuration section 1304 acquires the command received by the command reception section 1303. And, the command information configuration section 1304 configures the command information including these acquired commands and the apparatus discernment information. For example, when the transmission and the reception of the abnormal notice information, and the transmission and the reception of the command information are performed using the electronic mail, the command information configuration section 1304 configures the command information, to which the command received by the command reception section 1303 has been added, to the reply e-mail corresponding to the abnormal notice information specifying the server apparatus 12 from which the abnormal notice information as the addressee. Since not less than one apparatus discernment information included in the abnormal notice information, which is the e-mail being the origin, is included in the reply mail, the command information including the command and not less than one abnormal notice information is configured. There is no specific restriction for the timing and the trigger for the command information configuration section 1304 to configure the command information. For example, the command information may be configured when the instruction configuring the command information is received, and as mentioned above, the command information may be configured based on the instruction for creating the reply e-mail to the abnormal notice information received by the client side reception section as the trigger. The command information configuration section 1304 may usually be realized from the MPU and the memory. The processing procedure of the server update execution section 1217 is usually realized by the software, and the software is recorded on the recording medium, such as the ROM. However, the processing procedure of the server update execution section 1217 may be realized by the hardware (dedicated circuit).

The command information transmission section 1305 transmits the command information to the server apparatus 12. There is no specific restriction for how the command information transmission section 1305 acquires the information of the server apparatus 12 being the addressee. For example, in advance, the command information transmission section 1305 may read the address information, such as the e-mail address or the IP address of the server apparatus 12, accumulated in the memory (not illustrated), and may transmit the command information as the addressee of this address information. In addition, the command information transmission section 1305 acquires the IP address (for example, IP address of FROM) of the origin of the transmission included in the header of the abnormal notice information received by the client side reception section 1301. By transmitting the command information by specifying this IP address to the addressee, the command information may be transmitted to the server apparatus 12 from which the abnormal notice information has been transmitted. In addition, when the abnormal notice information has been transmitted via the electronic mail, the e-mail address from which the electronic mail has been transmitted is acquired. By transmitting the command information to this e-mail address via the electronic mail, the command information may be transmitted to the server apparatus 12 from which the abnormal notice information has been transmitted. The command information transmission section 1305 is realized by the communication method of the cable or the wireless.

The status information reception section 1306 receives the transmission status information transmitted from the server apparatus 12. For example, the status information reception section 1306 receives the transmission status information including the status information, such as the measurement information or the log of the manufacturing apparatus 11 transmitted via the electronic mail. The status information reception section 1306 is realized by the communication method of the cable or the wireless.

The status information output section 1307 outputs the transmission status information received by the status information reception section 1306. The output mentioned here denotes a concept including the displaying to the display unit, the transmission to an external apparatus, and accumulation to a storage medium. For example, once the transmission status information is accumulated to the storage medium, such as a hard disk, further, this transmission status information may be displayed on the display according to a certain trigger or instruction. The status information output section 1307 may be thought as to include or not to include the output device, such as a display. The status information output section 1307 may be realized by the driver software of the output device, or the driver software of the output device, and the output device.

The update information reception section 1308 receives the update information being the information for updating the desired manufacturing apparatus 11. The update information is the information for updating the desired manufacturing apparatus 11, for example, a program used for update, a patch, a script for rewriting the setting information, and a file to be added or replaced. The update information reception section 1308 is realized by the communication method of the cable or the wireless.

The update instruction information configuration section 1309 configures the update instruction information including the update information received by the update information reception section 1308, and the apparatus discernment information included in the abnormal notice information received by the client side reception section 1301. For example, when transmission of the update instruction information, which will be described later, is performed using the electronic mail, the update instruction information configuration section 1309 configures the update instruction information which attaches the above mentioned update information to the reply e-mail having the apparatus discernment information included in the abnormal notice information corresponding to the abnormal notice information specifying the server apparatus from which the abnormal notice information has been transmitted to the addressee. Specifically, when the reply e-mail regarding the electronic mail having the abnormal notice information is created, usually, the e-mail address of the origin of the transmission is specified as the e-mail address of a reply addressee, and the electronic mail, which has quoted the content of the electronic mail of the abnormal notice information being the electronic mail of the origin of the transmission, a title, and header information is created. Therefore, the apparatus discernment information included in the abnormal notice information will be included in the reply e-mail. Therefore, by attaching this update information to this reply e-mail, the update instruction information that includes the apparatus discernment information and the update information is configured. The update instruction information configuration section 1309 may usually be realized from the MPU and the memory. The processing procedure of the update instruction information configuration section 1309 is usually realized by the software, and the software is recorded on the recording medium, such as the ROM. However, the processing procedure of the update instruction information configuration section 1309 may be realized by the hardware (dedicated circuit).

The update instruction information transmission section 1310 transmits the update instruction information configured by the update instruction information configuration section 1309 to the server apparatus 12. There is no specific restriction for how the update instruction information transmission section 1310 acquires the information of the server apparatus 12 being the addressee. For example, in advance, the address information, such as an e-mail address or an IP address of the server apparatus 12 accumulated in the memory (not illustrated) is read out by the update instruction information transmission section 13 10, and the update instruction information may be transmitted by having this address information as the addressee. In addition, the update instruction information transmission section 1310 acquires the IP address (for example, IP address of FROM) of the origin of the transmission included in the header of the abnormal notice information received by the client side reception section 1301. By specifying this IP address as an addressee, and transmitting the command information, the update instruction information transmission section 1310 may transmit the command information to the server apparatus 12 from which the abnormal notice information has been transmitted. In addition, when the abnormal notice information has been transmitted via the electronic mail, the e-mail address from which the electronic mail has been transmitted is acquired, and the command information may be transmitted to the server apparatus 12 from which the abnormal notice information has been transmitted to this e-mail address by transmitting the command information via electronic mail. For example, when the update instruction information configuration section 1309 configures the update instruction information, which the update information has been attached to the reply e-mail of the electronic mail including the above-mentioned abnormal notice information, since the e-mail address of the addressee of this reply e-mail serves as the addressee of the server apparatus 12, the update instruction information can be transmitted to the server apparatus 12 by transmitting this reply e-mail. The update instruction information transmission section 1310 is realized by the communication means of the cable or wireless.

The server update information reception section 1311 receives the server update information for having the server apparatus 12 executes the update. The server update information is the information for updating the server apparatus 12, for example, the program used for the update, the script for rewriting the setting information, and the file for adding or replacing. The server update information reception section 1311 is realized by the communication means of the cable or the wireless.

The server update information transmission section 1312 transmits the server update information received by the server update information reception section 1311 to the server apparatus 12. There is no specific restriction for how the information of the server apparatus 12 being the addressee is acquired by the server update information transmission section 1312. For example, the address information on the server apparatus 12 is acquired in the same way as the update instruction information transmission section 1310 mentioned above. In addition, the server update information transmission section 1312 may transmit the server update information to the server apparatus 12 in any way. For example, the server update information may be transmitted to the server apparatus 12 by being attached to the electronic mail. In addition, the server update information may be transmitted by being attached to the reply e-mail of the electronic mail including the abnormal notice information transmitted from the server apparatus 12. The server update information transmission section 1312 is realized by the communication means of the cable or the wireless.

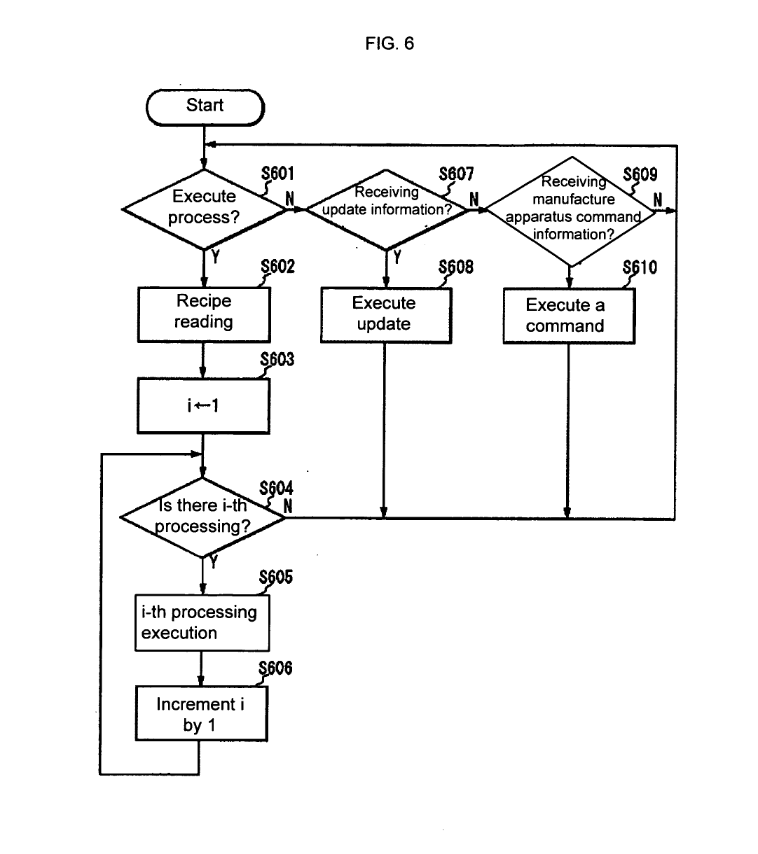

Next, the operation of the group control system is explained. First, the operation of the manufacturing apparatus 11 is explained using the flowchart of FIG. 6.

(STEP S601) The process section 1105 determines whether the process based on a predetermined recipe is executed. For example, when the input reception section 1101 receives the instruction for instructing the execution of the process by a predetermined recipe, it is determined that the process to be executed. When executing the process, the step proceeds to STEP S602 and when not executing the process, the step proceeds to STEP S607.

(STEP S602) The process section 1105 reads the predetermined recipe of the recipe storage section 1102.

(STEP S603) The process section 1105 substitutes 1 for Counter i.

(STEP S604) The process section 1105 determines whether the i-th processing step exists in the recipe read at STEP S602. When the i-th processing step exists, the step proceeds to STEP S605 and when the i-th processing step does not exist, the step returns to STEP S601.

(STEP S605) The process section 1105 executes the process of the i-th processing step.

(STEP S606) The process section 1105 increments the value of Counter i by 1. And it returns to STEP S604.

(STEP S607) The update information reception section 1108 determines whether the update information has been received. When the update information has been received, the step proceeds to STEP S608, and when the update information has not been received, the step returns to STEP S601.

(STEP S608) The update execution section 1109 executes the update of the manufacturing apparatus 11. In addition, regarding the execution of the update, since it is a well-known technique, description will be omitted. In addition, in this STEP, it is not necessary to execute the update in the case where the update information is executed at the time of the reboot of the manufacturing apparatus 11. And the step returns to STEP S601.

(STEP S609) The manufacturing apparatus command information reception section 1112 determines whether the manufacturing apparatus command information has been received. When the apparatus command information has been received, the step proceeds to STEP S610, and when the apparatus command information has not been received, the step returns to STEP S601.

(STEP S610) The process section 1105 executes the command included in the manufacturing apparatus command information. For example, when the command included in the manufacturing apparatus command information is a command for transmitting the desired status information (for example, the log) of the status information stored in the manufacturing apparatus status information storage section 1111, the process section 1105 acquires the desired status information from the manufacturing apparatus status information storage section 1111, and transmits the status information to the server apparatus 12 from the status information transmission section 1107. And the step returns to STEP S601.

In addition, here, although it is not illustrated in the above-mentioned flowchart, the acquisition of the measurement information of the gas mass flow and the temperature by the measurement section 1106 shall be performed by a timer interruption at the predetermined intervals. And whenever the measurement information having the information of the measurement time by the measurement section 1106 is acquired, the status information acquisition section 1104 sequentially acquires the measurement information from the measurement section 1106, and acquires the status information by adding the acquired time information. And the apparatus discernment information stored in the apparatus discernment information storage section 1103 is correlated with this status information, and is transmitted to the server apparatus 12 from the status information transmission section 1107. However, by having the measurement section 1106 add the time information, the status information acquisition section 1104 may be arranged to acquire the measurement information, to which this time information has been added, as the status information. In addition, the manufacturing apparatus status information accumulation section 1110 accumulates the status information acquired by the status information acquisition section 1104 into the manufacturing apparatus status information storage section 1111. In addition, the status information transmission section 1107 is assumed to have the information for communicating with the server apparatus 12 (For example, IP address of the server apparatus 12).

In addition, in the above-mentioned flowchart, at immediately after the process section 1105 has started or ended the execution of the process of STEP S601 and STEP S604, the process section 1105 may be arranged to output the information regarding the utilization status of the manufacturing apparatus 11, such as, the information regarding the process performed by the process section 1105, for example, the discernment information distinguishing the process, such as, a process name and a recipe name of the process, which started the execution, to the status information acquisition section 1104 with the information of the time at which the information was acquired. And the status information acquisition section 1104 may be arranged to acquire the information outputted by this process section 1105 as the status information at any time. In addition, the status information acquisition section 1104 may be arranged to add the time information. And the apparatus discernment information stored in the discernment information storage section 1103 is correlated with this status information and is transmitted to the server apparatus 12 from the status information transmission section 1107.

In addition, in the flowchart of FIG. 6, the process ends by power OFF or the interruption of termination of the process.

Next, the operation of the server apparatus 12 will be explained using the flowchart of FIG. 7. In addition, here, the case where the abnormal detection is performed based on the desired status information set up in advance will be explained. In addition, here, the case where the command received by the command information reception section 1209 is a command for executing the process for allowing the client apparatus 13 to transmit the transmission status information will be explained as an example.

(STEP S701) The server side reception section 1201 determines whether the status information transmitted from the manufacturing apparatus 11 has been received. When the status information transmitted from the manufacturing apparatus 11 has been received, the step proceeds to STEP S702, and when the status information transmitted from the manufacturing apparatus 11 has not been received, the step proceeds to STEP S708.

(STEP S702) The accumulation section 1202 stores the status information received at STEP S701, and the apparatus discernment information correlated with the status information in the status information storage section 1203. For example, here, the apparatus discernment information is assumed to be transmitted with the status information.

(STEP S703) The abnormal detection section 1205 determines whether the status information received in STEP S701 is predetermined status information, which falls within the target of the abnormal detection. For example, it is possible to determine whether it is the predetermined status information by adding the information of the above-mentioned data type to the status information, and deciding whether the information on the data type of status information is the predetermined data type set up in advance. When it is the predetermined status information, the step proceeds to STEP S704, and when it is not the predetermined status information, the step returns to STEP S701.

(STEP S704) By using the condition information stored in the condition information storage section 1204 to the status information received at STEP S701, the abnormal detection section 1205 performs abnormal detection, and determines whether the abnormality has been detected or not. When the abnormality has been detected, the step proceeds to STEP S705, and when the abnormality has not been detected, the step returns to STEP S701.

(STEP S705) The abnormal notice information configuration section 1206 acquires the apparatus discernment information correlated with the status information from which the abnormality has detected in STEP S704, and configures the abnormal notice information using this apparatus discernment information.

(STEP S706) The server side transmission section 1208 acquires the apparatus discernment information correlated with the status information from which the abnormality has been detected in STEP S704, and acquires the addressee information of not less than one client apparatuses 13 corresponding to the manufacturing apparatus 11, from which the abnormality has been detected, from the addressee information per apparatus stored in the addressee information per apparatus storage section 1207 using this apparatus discernment information.

(STEP S707) The server side transmission section 1208 transmits the abnormal notice information configured in STEP S705 to the client apparatus 13 corresponding to the manufacturing apparatus 11 from which the abnormality has been detected using the addressee information acquired in STEP S706. And the step returns to STEP S701.

(STEP S708) The command information reception section 1209 determines whether the command information has been received. When the command information has been received, the step proceeds to STEP S709, and when the command information has not been received, the step proceeds to STEP S711.

(STEP S709) The command execution section 1210 determines whether the command included in the command information received in STEP S708 is a command for the manufacturing apparatus 11 to execute. When it is the command for the manufacturing apparatus 11 to execute, the step proceeds to STEP S710, and when it is not the command for the manufacturing apparatus 11 to execute, the step proceeds to STEP S716.

(STEP S710) The command execution section 1210 executes the command included in the command information received in STEP S708. As an example here, assuming that the command information is the command acquiring and transmitting the transmission status information, the command execution section 1210 outputs the instruction for configuring the transmission status information configured by the status information of the desired kind corresponding to the apparatus discernment information included in the command information to the transmission status information acquisition section 1211. In response to this instruction, the transmission status information acquisition section 1211 acquires the status information of the desired kind corresponding to the apparatus discernment information included in the command information from the status information storage section 1203, and configures the transmission status information. And the transmission status information transmission section 1212 transmits the transmission status information acquired in STEP S709 according to the instruction of the command execution section 1210 to the client apparatus 13 of the addressee of the command information. The address information of the addressee of the command information, for example, is acquired from the command information. And it returns to STEP S701. In addition, here, although the case where the command information was the command for acquiring and transmitting the transmission status information was explained, the command information may be other command information.

(STEP S711) The update instruction reception section 1214 determines whether the update instruction information has been received. When the update instruction information has been received, the step proceeds to STEP S712, and when the update instruction information has not been received, the step proceeds to STEP S714.

(STEP S712) The update information transmission section 1215 acquires the addressee apparatus information corresponding to the apparatus discernment information included in the update instruction information received in STEP S711, for example, by the search from the manufacturing apparatus addressee information stored in the manufacturing apparatus addressee information storage section 1213.

(STEP S713) The update information transmission section 1215 transmits the update information using the addressee apparatus information acquired in STEP S712. And the step returns to STEP S701.

(STEP S714) The server update information reception section 1216 determines whether the server update information has been received. When the server update information has been received, the step proceeds to STEP S715, and when the server update information has not been received, the step returns to STEP S701.

(STEP S715) The server update execution section 1217 updates the server apparatus 12 by using the server update information received in STEP S714. And it returns to STEP S701.

(STEP S716) The command execution section 1210 configures the manufacturing apparatus command information corresponding to the command information received in STEP S708.

(STEP S717) The command execution section 1210 acquires the addressee information of the manufacturing apparatus command information using the apparatus discernment information included in the command information.

(STEP S718) The manufacturing apparatus command information transmission section 1218 transmits the manufacturing apparatus command information configured in STEP S716 using the addressee information acquired in STEP S717. Specifically, the address indicated by addressee information is specified as the address of the addressee, and the manufacturing apparatus command information is acquired and transmitted. And the step returns to STEP S701.

In addition, in the flowchart of FIG. 7, the process is ended by power OFF or the interruption of termination of the process.

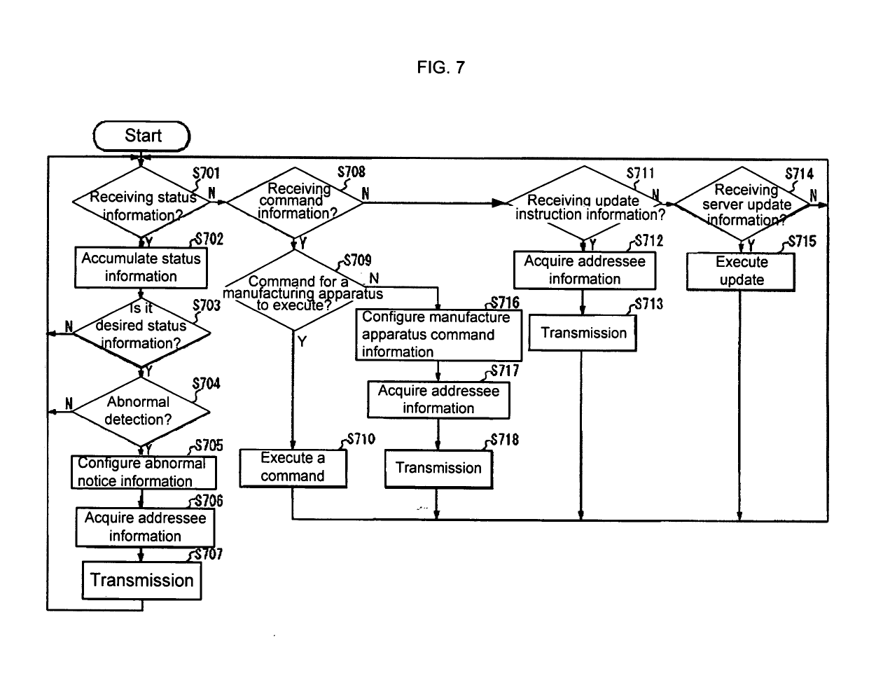

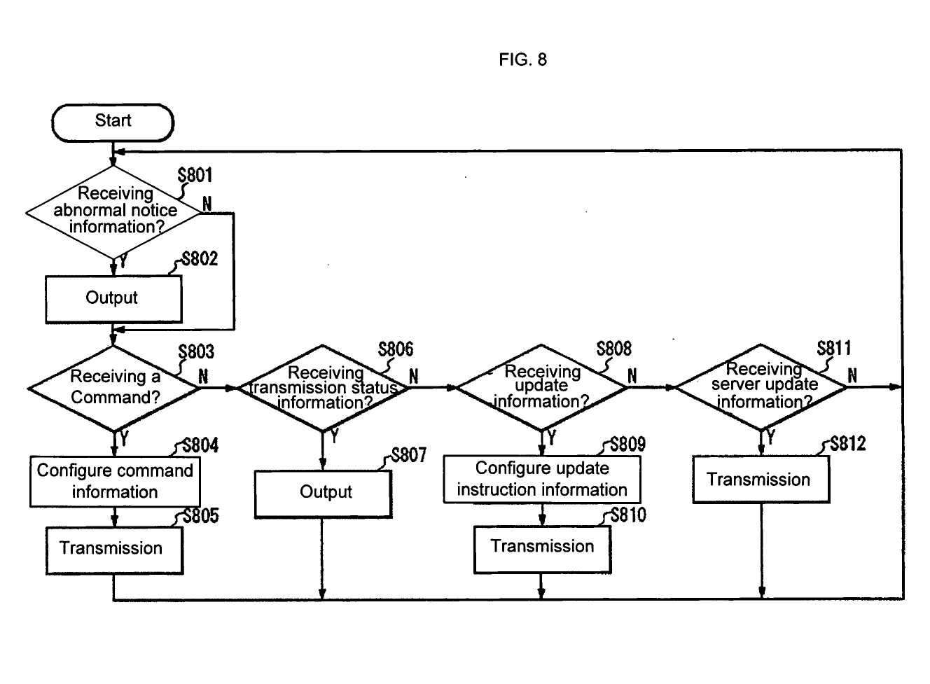

Next, the operation of the client apparatus 13 will be explained using the flowchart of FIG. 8.

(STEP S801) The client side reception section 1301 determines whether the abnormal notice information has been received. When the abnormal notice information has been received, the step proceeds to STEP S802, and when the abnormal notice information has not been received, the step proceeds to STEP S803.

(STEP S802) The output section 1302 outputs the abnormal notice information received in STEP S801. For example, the received abnormal notice information is accumulated in the memory, further, the abnormal notice information is displayed.

(STEP S803) The command reception section 1303 determines whether the command has been received. When the command has been received, the step proceeds to STEP S804, and when the command has not been received, the step proceeds to STEP S806.

(STEP S804) The command information configuration section 1304 configures the command information using the apparatus discernment information included in the abnormal notice information received in STEP S801, and the command received in STEP S803.

(STEP S805) The command information transmission section 1305 transmits the command information configured in STEP S804 to the server apparatus 12. For example, the command information transmission section 1305 transmits the command information to the server apparatus 12 using the address information, from which the abnormal notice information has been transmitted, which is included in the abnormal notice information received in STEP S801. And it returns to STEP S801.

(STEP S806) The status information reception section 1306 determines whether the transmission status information has been received. When the transmission status information has been received, the step proceeds to STEP S807, and when the transmission status information has not been received, the step proceeds to STEP S808.

(STEP S807) The status information output section 1307 outputs the transmission status information received in STEP S806. And the step returns to STEP S801.

(STEP S808) The update information reception section 1308 determines whether the update information has been received. When the update information has been received, the step proceeds to STEP S809, and when the update information has not been received, the step proceeds to STEP S811.

(STEP S809) The update instruction information configuration section 1309 configures the update instruction information using the update information and the apparatus discernment information included in the abnormal notice information received in STEP S801.

(STEP S810) The update instruction information transmission section 1310 transmits the update instruction information configured in STEP S809 to the server apparatus 12. For example, the update instruction information transmission section 1310 transmits the update instruction information to the server apparatus 12 using the address information, from which the abnormal notice information has been transmitted, which is included in the abnormal notice information received in STEP S801. And the step returns to STEP S801.

(STEP S811) The server update information reception section 1311 determines whether the server update information has been received. When the server update information has been received, the step proceeds to STEP S812, and when the server update information has not been received, the step returns to STEP S801.

(STEP S812) The server update information transmission section 1312 transmits the server update information received in STEP S811 to the server apparatus 12. For example, the server update information transmission section 1312 transmits the server update information to the server apparatus 12 using the address information, from which the abnormal notice information has been transmitted, which is included in the abnormal notice information received in STEP S801. And the step returns to STEP S801.

In addition, in the flowchart of FIG. 8, the process is ended by power OFF or the interruption of termination of the process.

Hereafter, a specific operation of the group management system in an embodiment of the present invention will be explained. The conceptual diagram of a group management system is illustrated in FIG. 1.

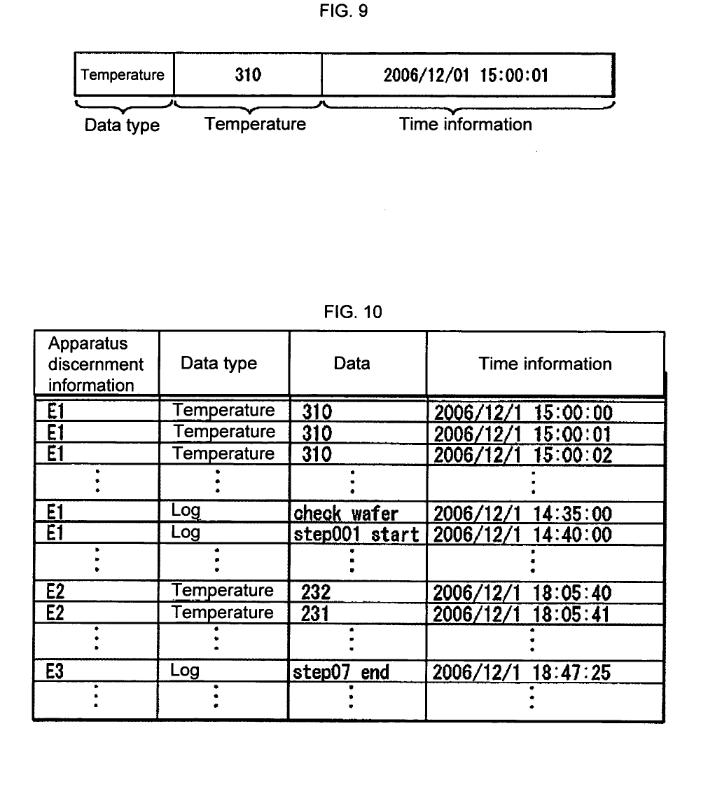

In this example, when the input reception section 1101 of not less than one manufacturing apparatus 11 receives the starting instruction of the processing treatment to the substrate to be processed from a user, for example, a wafer, the process section 1105 reads out the recipe in the recipe storage section 1102, executes the read recipe and advances the processing treatment of wafer. The measurement section 1106 measures the temperature under the processing treatment of the wafer (for example, the temperature of the inside of the furnace determined in advance for every second), and acquires the temperature, which is the measurement information. The status information acquisition section 1104 respectively acquires the measurement information from the measurement section 1106, here it is concretely the temperature and the time information from a clock, which is not illustrated, and configures and acquires the status information in which the measurement information and the time information are paired. FIG. 9 illustrates the example of this status information. The status information includes the data type, the temperature and the time information. The information of the data type is information, which shows the type of data of the measurement information, including a gas flow rate, temperature and a pressure, and here it is information, which shows that it is temperature. A However, the information of data type may be omitted depending on a situation. Although, here, the status information acquisition section 1104 is arranged to add the information of this data type, the measurement section 1106 may be arranged to add the information of this data type to the measurement information. The time information is information, which shows time, which may be the time information specifying hour, minute and second or may be time information showing the day and the time. In addition, here, although the measurement information was considered as the temperature, in addition to the temperature or in place of the temperature, the other measurement information, such as the gas flow and the pressure, may be included. Furthermore, the discernment information of a recipe currently being used or a recipe corresponding to the process means, and the discernment information of the process means may be added to the status information. In addition, the status information acquisition section 1104 acquires, at any time, what is called a log of the manufacturing apparatus 11 being the information showing that the start and the end of the prescribed process outputted when the process section 1105 starts or completes the prescribed process has been performed. The status information is acquired by configuring the status information in which the acquired log and the time information acquired from a clock, which has not been shown, are paired. This status information becomes the information, which has replaced the temperature being the measurement information with the log and the information of the data type with the information showing that it is information using the log. Here, the information on this data type is arranged to be added to the status information, which the status information acquisition section 1104 configured using the log acquired from the process section 1105. The status information transmission section 1107 adds the apparatus discernment information of the manufacturing apparatus 11 acquired from the apparatus discernment information storage section 1103 to the status information which was acquired by doing as described above, and transmits it to the server apparatus 12 sequentially.

Next, the server side reception section 1201 of the server apparatus 12 sequentially receives the status information, which became a pair with the apparatus discernment information sequentially transmitted from the manufacturing apparatus 11. And the accumulation section 1202 accumulates the accumulated status information to the status information storage section 1203. An example of this status information is shown in FIG. 10. FIG. 10 shows a status information control table, which manages the status information. The status information control table has the attribute of “manufacturing apparatus discernment information”, “data type”, “data”, and “time information”. The “Apparatus discernment information” is the apparatus discernment information of the manufacturing apparatus 11 from which the status information received with the status information has been transmitted. The “data type” and the “time information” are the data types and the time information, which are included in the status information. The “Data” is data of the measurement information and the log included in the status information. In addition, the status information control table may be provided according to the data type. For example, a plurality of records whose “data type” is “log” and a plurality of records whose “data type” is “temperature” may be respectively managed by the different status information control tables in FIG. 10.

Next, the abnormal detection section 1205 sequentially performs abnormal detection on the measurement information, here being the temperature, included in the status information received by the server side reception section 1201. Concretely, it is assumed that the condition information “330≦temperature≦400” by a threshold value to determine the normality/abnormality of the temperature of the manufacturing apparatus whose apparatus discernment information is “E1” is stored in the condition information storage section 1204 in advance. For example, supposing that the data type of status information received by the server side reception section 1201 is “temperature” and the apparatus discernment information correlated with this status information is “E1”, the condition information corresponding to the data type being the “temperature” and the apparatus discernment information being “E1” is searched and acquired from the condition information storage section 1204. Then, it is determined whether the value of the temperature included in the condition information satisfies the acquired condition information. Here, in case when the value of the temperature included in the status information is “310”, the abnormal detection section 1205 will determine that the above-mentioned condition information “330≦temperature≦400” is not satisfied, and will detect the occurrence of the abnormalities.

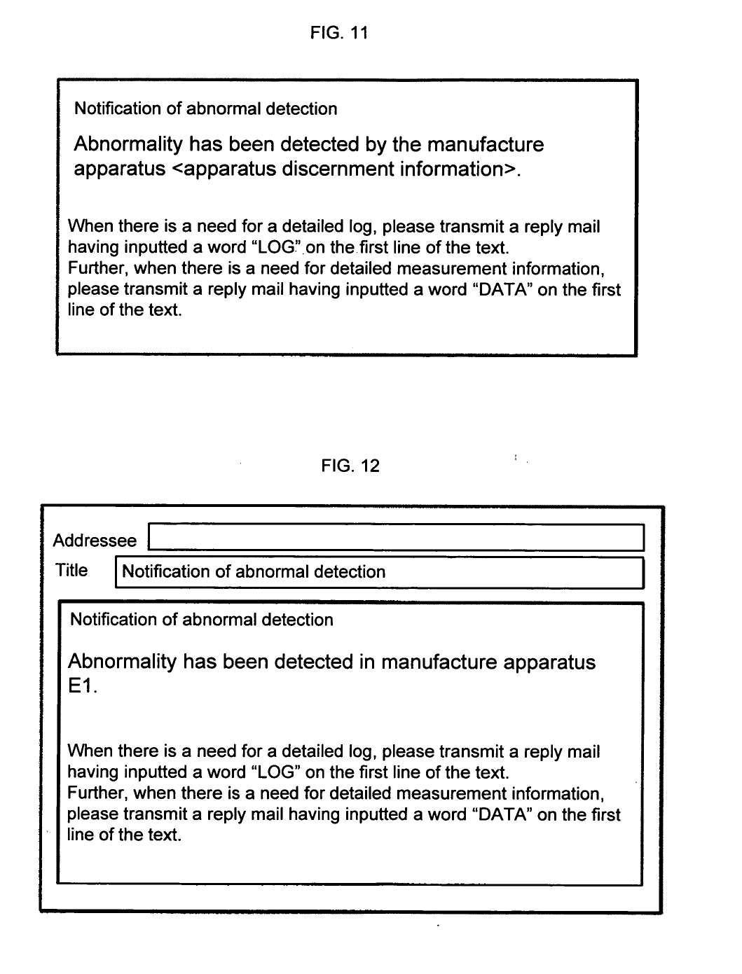

When the abnormal detection section 1205 detects the abnormalities, the abnormal notice information configuration section 1206 configures the abnormal notice information. For example, the abnormal notice information configuration section 1206 reads the information on the template of the electronic mails, such as a text file and an HTML file stored in storage media, such as a memory in advance, as shown in FIG. 11. In addition, the abnormal notice information configuration section 1206 acquires “E1”, which is the apparatus discernment information corresponding to the status information from which the abnormalities were detected. And a prescribed position into which the read apparatus discernment information of the template, which in here is a character string called “apparatus discernment information”, is replaced by the apparatus discernment information corresponding to the status information, and the abnormal notice information of an electronic mail format is configured.

FIG. 12 illustrates an example of the abnormal notice information configured by the abnormal notice information configuration section 1206. In addition, the title of the abnormal notice information is properly set to, for example, the character string of the first line of the template, the file name of the template and the apparatus discernment information of the manufacturing apparatus 11 from which the abnormalities were detected.

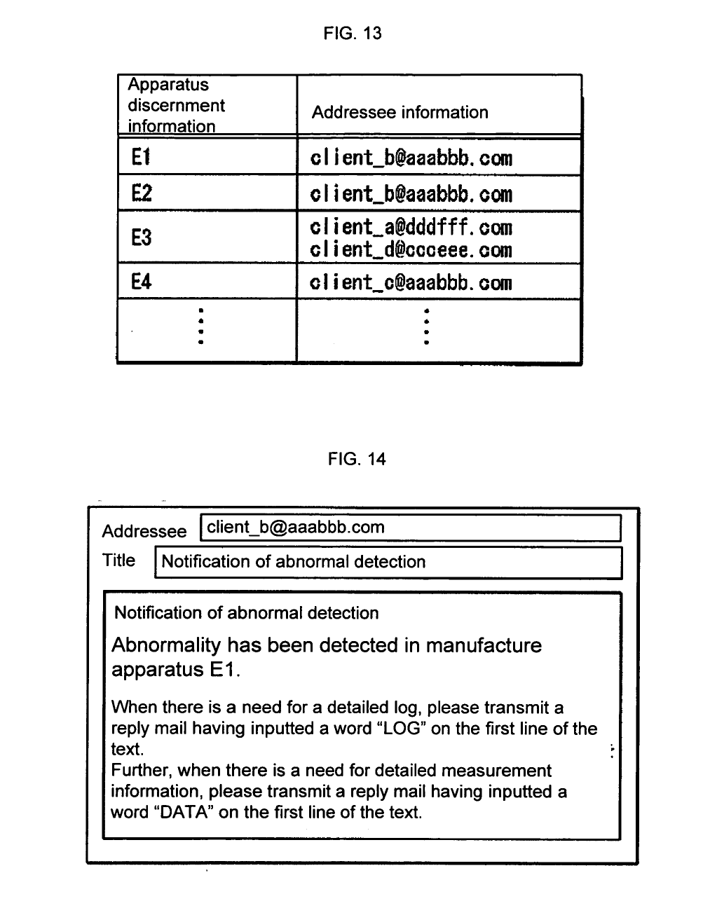

FIG. 13 illustrates an addressee information per apparatus control table, which manages the addressee information per apparatus stored in the addressee information per apparatus storage section 1207. The addressee information per apparatus control table has the attribute of “apparatus discernment information” and “addressee information.” The “apparatus discernment information” is the apparatus discernment information of the manufacturing apparatus 11. The “addressee information” is the addressee information of not less than one client apparatus 13, which becomes an addressee, especially in here it is the e-mail address.

The server side transmission section 1208 acquires the apparatus discernment information corresponding to the status information from which the abnormalities were detected from server side reception section 1201. The server side transmission section 1208 further searches the record having the “apparatus discernment information” matching to this apparatus discernment information from the addressee information per apparatus control table as shown in FIG. 12. Furthermore, the server side transmission section 1208 acquires the e-mail address, which is an attribute value of “addressee information” of the searched record. For example, the addressee information corresponding to the apparatus discernment information “E1” is supposedly “client_b@aaabbb.com”, which is an e-mail address of the client apparatus 13b here. And the electronic mail specifying this mail address as the addressee of the abnormal notice information as shown in FIG. 13 is configured. The configured electronic mail is shown in FIG. 14. And this electronic mail is transmitted. Thereby, the abnormal notice information is transmitted to the client apparatus 13 corresponding to the manufacturing apparatus 11 from which the abnormalities were detected via an electronic mail. In addition, the electronic mail address of the server apparatus 12 being the origin of the transmission is usually included in the electronic mail, for example as header information. Here, it is assumed that the e-mail address of the server apparatus 12 is “server@cccddd.com.”

In the client apparatus 13b, the abnormal notice information transmitted by the electronic mail from the server side transmission section 1208 is received, for example using electronic mail software. And while the output section 1302 accumulates the received abnormal notice information in the storage medium, such as the memory, it is displayed on the display, which are not illustrated here.

Next, the case where the user, who has received the abnormal notice information, collects the logs of the manufacturing apparatus 11 from which the abnormalities were detected, will be described. The user inputs the instructions for creating the reply e-mail to the electronic mail being the received abnormal notice information by operating the menu. The reply e-mail described here is concretely an electronic mail having the sender of the original electronic mail cited as an addressee. It is preferable to cite the title of the original electronic mail and the information on the text. For example, in case when the command reception section 1303 receives the instructions for creating the reply e-mail from a user, a whole sentence and the title of the received abnormal notice information are cited and the reply e-mail having the e-mail address “server@cccddd.com” of the server apparatus 12, from which the abnormal notice information has been transmitted, specified as the mail address of the addressee, is configured.

By this, “E1”, which is the apparatus discernment information of the manufacturing apparatus from which the abnormalities were detected, included in the abnormal notice information will be included in this reply e-mail. And when the user inputs the character string “LOG” using a keyboard to the first line of the reply mail, the command reception section 1303 will receive this command “LOG.” And the command information configuration section 1304 configures the command information, which has arranged the character string of the command “LOG” to the first line of the reply e-mail.

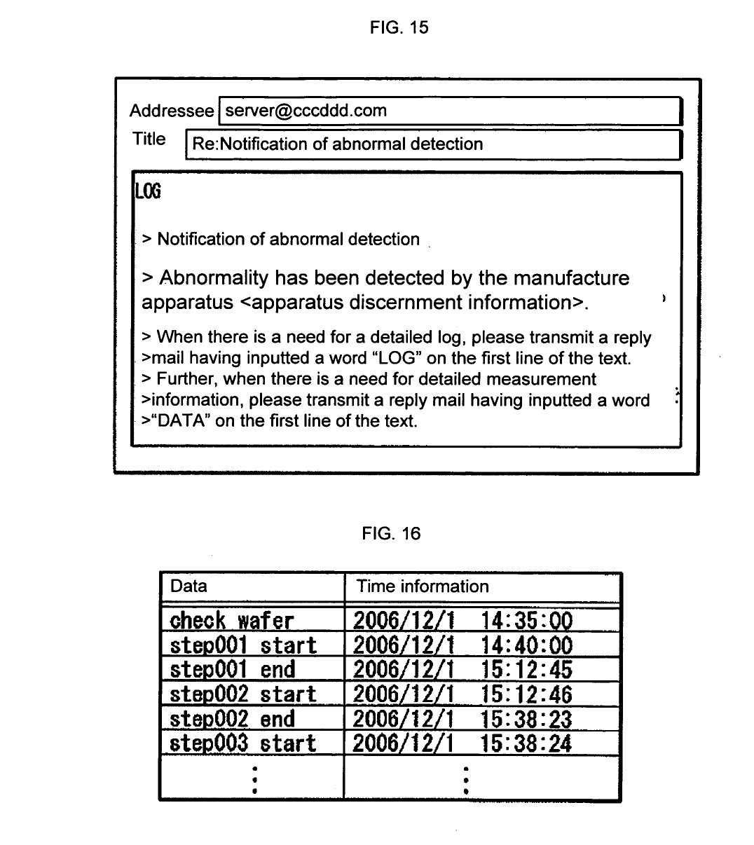

FIG. 15 illustrates an example of the command information configured by the command information configuration section 1304. Here, “LOG” is assumed to be the command, which instructs the server apparatus to collect the log of the manufacturing apparatus 11 corresponding to the apparatus discernment information included in the command information. However, the information, which specifies any one of not less than one manufacturing apparatuses 11, should not be included in the command “LOG” itself.

And the reply e-mail, to which the command information being “LOG” has been added here, is transmitted by having a user, for example, give the instructions for transmitting the reply e-mail using a mouse to the electronic mail software.

When the command information reception section 1209 of the server apparatus 12 receives the command information transmitted from the client apparatus 13b via the electronic mail, the command execution section 1210 reads the command included in the received command information, here, it is “LOG” being the command on the first line of the text of the electronic mail, which is the command information. This command information determines whether it is the command, which the server apparatus 12 executes. Here, since it is the command, which the server apparatus 12 executes, this command “LOG” is executed. Since this “LOG” is the command, which instructs the collection of the log of the manufacturing apparatus 11, the command execution section 1210 firstly acquires the apparatus discernment information included in the command information. Since the position where the apparatus discernment information is set in the command information is known in advance, it is possible to easily acquire the apparatus discernment information from the command information. Here, the apparatus discernment information “E1” is acquired from the command information. And the command for collecting the logs of the manufacturing apparatus 11 corresponding to this apparatus discernment information “E1” is executed.

The transmission status information acquisition section 1211 acquires the log being the status information having “data” corresponding to the record in which “apparatus discernment information” is “E1” and “data type” is “log”, and “time information” in the status information control table shown in FIG. 10 from the status information storage section 1203 in response to the instruction from the command execution section 1210, and configures the transmission status information.

FIG. 16 illustrates transmission status information configured by the transmission status information acquisition section 1211. The attributes of “data” and “time information” of FIG. 16 are the same attributes as that of the “data” and “time information” in FIG. 10. This transmission status information may be temporarily stored into a storage medium, such as the memory, as a file of a text file. In addition, the transmission status information may be configured, for example, by using a template. In addition, here, it is assumed that the apparatus discernment information “E1” corresponding to the transmission status information is added to the transmission status information.

The transmission status information transmission section 1212 acquires the e-mail address “client_b@aaabbb.com”, from which the command information has been received by the command information reception section 1209. The transmission status information transmission section 1212 configures the electronic mail having the transmission status information configured by the transmission status information acquisition section 1211 disposed in the text of the electronic mail using this acquired e-mail address as the e-mail address of the addressee. And, the transmission status information transmission section 1212 transmits the transmission status information configured by the transmission status information acquisition section 1211. In addition, instead of arranging the transmission status information in the text of the electronic mail, the transmission status information being a file, such as a text file, stored temporarily in the storage medium may be attached to the electronic mail, and may be transmitted therewith. With respect to a title of the electronic mail, a prescribed title may be utilized.

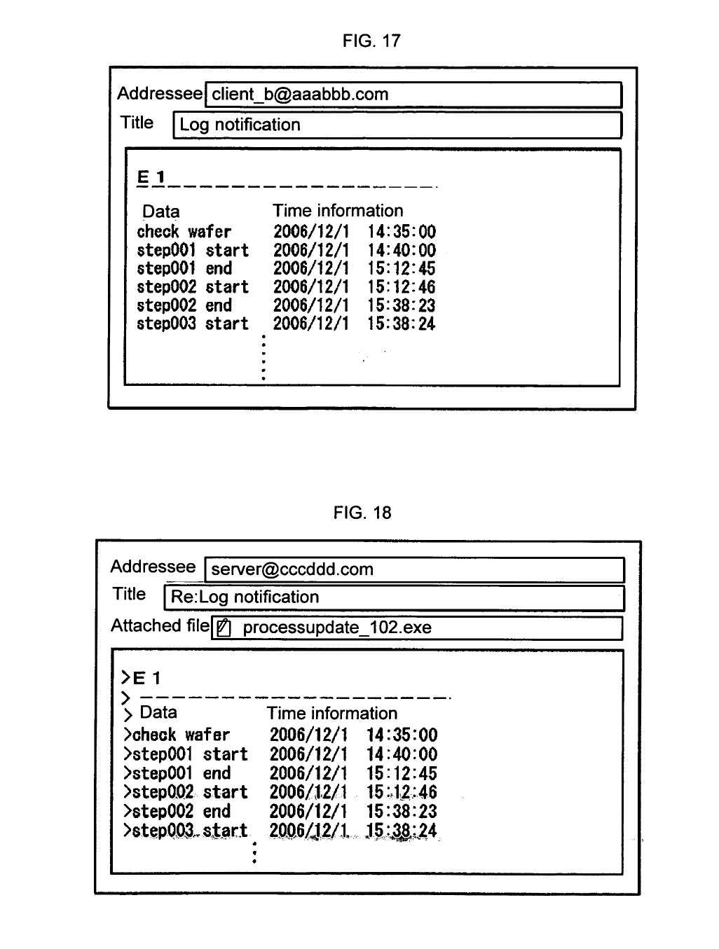

When the status information reception section 1306 of the client apparatus 13b receives the transmission status information transmitted from the transmission status information transmission section 1212 via the electronic mail, the status information output section 1307 accumulates the transmission status information received by the status information reception section 1306 in the storage medium, such as the memory. Then the status information output section 1307 displays the transmission status information on a display. FIG. 17 illustrates an example of the display of the transmission status information.

Next, suppose that the user has determined that the update of the manufacturing apparatus corresponding to this transmission status information is necessary from the result driven by the user studying the display of the transmission status information. And in order to perform the update, the instruction for creating the reply e-mail to the electronic mail of the received transmission status information is inputted by operating a menu. For example, if the update information reception section 1308 receives the instructions for creating the reply e-mail from the user, the update information reception section 1308 configures the reply e-mail having the e-mail address “server@cccddd.com” of the server apparatus 12 from which the transmission status information has been transmitted as the e-mail address of the addressee by citing the whole sentence and the title of the received transmission status information. Since “E1” being the apparatus discernment information of the manufacturing apparatus, in which the abnormalities had been detected, included in the abnormal notice information, was included in the transmission status information, the apparatus discernment information of the manufacturing apparatus, from which the abnormalities were detected, included in the abnormal notice information will also be included in the reply e-mail. And the user attaches “processupdata_{—}102.exe” being the update information of the manufacturing apparatus 11 read from CD to this reply E-mail using a mouse. By this, the update information reception section 1308 receives the update information, and the update instruction information configuration section 1309 configures the update instructions information having the update information and the apparatus discernment information. The example of the configured update instructions information is shown in FIG. 18. And, the update instructions information is transmitted to the server apparatus 12 via the electronic mail by the user transmitting the reply e-mail.

When the update instruction reception section 1214 receives the update instruction information transmitted from the client apparatus 13b via the electronic mail, the update information transmission section 1215 acquires the apparatus discernment information “E1” included in the update instruction information, and further acquires the manufacturing apparatus addressee information corresponding to this apparatus discernment information “E1”, which is concretely the IP address of the manufacturing apparatus 11, from the manufacturing apparatus addressee information storage section 1213. Here, it is assumed that the apparatus discernment information “E1” and the IP address of the manufacturing apparatus 11a are correlated and stored in the manufacturing apparatus addressee information storage section 1213. The update information transmission section 1215 acquires the IP address of the manufacturing apparatus 11a corresponding to the apparatus discernment information “E1”. And by setting this IP address as an addressee, the update information transmission section 1215 transmits the update information included in the update instructions information by FTP and transmits the update information to the manufacturing apparatus 11a.

When the update information reception section 1108 of the manufacturing apparatus 11a receives the update information transmitted from the server apparatus 12, the update execution section 1109 will update the manufacturing apparatus 11a using this update information. In addition, the update execution section 1109 may be arranged to temporarily accumulate the update information received by the update information reception section 1108 into a storage medium, such as a memory, and to conduct the update at a prescribed timing, for example, the timing at when the manufacturing apparatus 11a is rebooted. In addition, regarding the update process of the manufacturing apparatus 11, since it is well-known technology, explanation will be omitted. In addition, the update information may be transmitted to the manufacturing apparatus 11 via the electronic mail using the manufacturing apparatus addressee information as the e-mail address of the manufacturing apparatus 11.

On the other hand, suppose that the user has determined that the update of the server apparatus 12 is needed from the result by studying the display of the transmission status information. And in order to conduct update, the instruction for creating the reply e-mail by operating the menu is inputted to the electronic mail of the received transmission status information. For example, in case when the update information reception section 1308 receives the instructions for creating the reply e-mail from the user, the reply e-mail specifying the e-mail address “server@cccddd.com” of the server apparatus 12, from which the transmission status information has been transmitted as the e-mail address of the addressee, is configured by citing the whole sentence and title of the received transmission status information. And when the user attaches “serverupdata_{—}301.exe” being the update information of the server apparatus 12 read from CD to this reply e-mail using a mouse, the server update information reception section 1311 receives the server update information. And the server update information is transmitted to the server apparatus 12 by having the user transmit the reply e-mail.

In case when the server update information reception section 1216 receives the server update information transmitted via the electronic mail from the client apparatus 13b, the server update execution section 1217 will update the server apparatus 12 by using this server update information. In addition, the server update execution section 1217 may once accumulate the server update information received by the server update information reception section 1216 to the storage medium, such as the memory, and may conduct the update at the timing when the server apparatus 12 is rebooted. In addition, with respect to the update process of the server apparatus 12, since it is well-known technology, explanation will be omitted.

In addition, whether the information transmitted from the client apparatus 13 is received by the reception sections of the command information reception section 1209 or the update instruction reception section 1214 or the server update information reception section 1216 may be determined, for example, by using the information included in the received information, for example, the command and the attached update information. In addition, while realizing these reception sections by one reception section, this one reception section may be arranged to operate as any one of the command information reception section 1209, the update instruction reception section 1214 and the server update information reception section 1216 corresponding to the received information,.

In addition, in the above-mentioned example, by using the reply e-mail of the transmission status information, the update instruction information was configured and transmitted, and the server update information was transmitted. However, by using the reply e-mail of the abnormal notice information, the update instruction information may be configured and transmitted, and the server update information may be transmitted.

In addition, in the above-mentioned example, the transmission and reception of the abnormal notice information, the transmission and reception of the command information, the transmission and reception of the transmission status information, the transmission and reception of the update instruction information and the transmission and reception of the server update information have been performed by using the electronic mail. However, these transmissions and receptions may be arranged to be performed by using other communication means.

In addition, in the above-mentioned example, the command information including the command for acquiring the log of the manufacturing apparatus 11 stored in the server apparatus 12 as the command information was transmitted to the server apparatus 12. However, it may be allowed to acquire any status information of the manufacturing apparatus 11, such as measurement information other than the log of the manufacturing apparatus 11, by giving the command other than the command for acquiring the log.

In addition, in the above-mentioned example, although in order to collect the logs of the manufacturing apparatus 11, it had been arranged to input the command “LOG”, it may be arranged to only transmit the reply e-mail of the abnormal notice information. The command execution section 1210 of the server apparatus 12 may execute the prescribed command, such as configuring and transmitting the transmission status information, such as a log, corresponding to this reply electronic mail. In this case, the reception of the instruction for creating the reply e-mail from the user will be equivalent to receiving the prescribed command.

In addition, in the above-mentioned example, although the command information including the command to be executed by the server apparatus 12, concretely, the command for acquiring the log of the manufacturing apparatus 1 stored in the server apparatus 12, is transmitted as the command information, the command information including the command to be executed by the manufacturing apparatus 11 may be transmitted. Hereafter, the case where the logs of the manufacturing apparatus 11 from which abnormalities were detected are collected from the manufacturing apparatus 11 by transmitting the command information including the command to be executed by the manufacturing apparatus 11 will be explained.

First, with regards to a process until the reception of the abnormal notice information from the server apparatus 12, it is the same as that of the above-mentioned example.

Next, a user inputs the instructions for creating a reply e-mail to the electronic mail, which is the received abnormal notice information as the same as the above-mentioned example by operating the menu. For example, in case when the command reception section 1303 receives the instructions for creating the reply e-mail from a user, the command reception section 1303 quotes the whole sentence and the title of the abnormal notice information and configures the reply e-mail specifying the electronic mail address “server@cccddd.com” of the server apparatus 12 from which the abnormal notice information has been transmitted, as the e-mail address of the addressee. By this, “E1” which is the apparatus discernment information of the manufacturing apparatus from which the abnormalities were detected being included in the abnormal notice information will be included in this reply e-mail. And when the user inputs the sample sentence “device_LOG” into the first line of the reply e-mail by using a keyboard, the command reception section 1303 will receive this “device_LOG” command. And the command information configuration section 1304 configures the command information to which the sample sentence of the “device_LOG” command has been arranged to the first line of the reply e-mail.

FIG. 18 illustrates the example of the command information configured by the command information configuration section 1304. Here, “device_LOG” is to be the command for instructing the transmission of a log to not less than one manufacturing apparatuses 11 in which the abnormalities have occurred. However, the information specifying any one of not less than one manufacturing apparatuses 11, should not be included in this “device_LOG” being the command itself.

And the reply e-mail to which the command information being the command “device_LOG” here, has been added is transmitted by a user giving, for example, the instruction for transmitting the reply e-mail to electronic mail software using a mouse.

When the command information reception section 1209 of the server apparatus 12 receives the command information transmitted from the client apparatus 13b by the electronic mail, the command execution section 1210 is arranged to read “device_LOG” being the instruction on the first line of the text of the electronic mail being the command information, here, the command included in the received command information. Here, the command information reception section 1209 determines that this command information is the command to be executed by the manufacturing apparatus 11 from which the abnormalities were detected, and configures the manufacturing apparatus command information corresponding to this command. Here, it is assumed that the manufacturing apparatus command information including a command called “device_LOG”, which is the same as the command included in the command information, is configured. Furthermore, the command information reception section 1209 acquires the apparatus discernment information “E1” included in the command information. The command information reception section 1209 acquires the manufacturing apparatus addressee information corresponding to this apparatus discernment information “E1”, concretely, the IP address of the manufacturing apparatus 11 from the manufacturing apparatus addressee information storage section 1213 as the same as the above-mentioned update information transmitting section 1215. And the manufacturing apparatus command information transmission section 1218 transmits the manufacturing apparatus command information by using an IP protocol by setting this IP address as an addressee. Thereby, the manufacturing apparatus command information is transmitted to the manufacturing apparatus 11a.

In case when the manufacturing apparatus command information reception section 1112 of the manufacturing apparatus 11a corresponding to the apparatus discernment information “E1” receives the manufacturing apparatus command information including the command “device_LOG” from the server apparatus 12, the process section 1105 will execute this “device_LOG” command. Concretely, the manufacturing apparatus command information reception section 1112 collects and acquires the logs stored in the manufacturing apparatus status information storage section 1111, and transmits the acquired log from the status information transmission section 1107 to the server apparatus 12 from which the manufacturing apparatus command information has been transmitted.

In case when the server side reception section 1201 of the server apparatus 12 receives the log corresponding to the manufacturing apparatus instruction information including the command “device_LOG”, which the manufacturing apparatus command information transmission section 1218 transmitted, from the status information transmission section 1107 of the manufacturing apparatus 11a, the transmission status information configuration section 1211 configures the transmission status information including this log. And the transmission status information configuration section 1211 transmits the configured transmission status information via an electronic mail to the origin of the transmission of the command information corresponding to the manufacturing apparatus instruction information including the command “deviceLOG”. Specifically, the transmission status information configuration section 1211 temporarily stores the instruction information including the command “device_LOG”, acquires the e-mail address of the client apparatus 13b from which this command information has been transmitted, and transmits the transmission status information by setting this e-mail address as the destination.

In case when the status information reception section 1306 of the client apparatus 13b receives the transmission status information transmitted through the electronic mail from the transmission status information transmission section 1212, the status information output section 1307 accumulates the transmission status information received by the status information reception section 1306 into the storage medium, such as the memory, and displays the transmission status information on a display as illustrated in FIG. 17.

In addition, here, the case where the command for acquiring the log of the manufacturing apparatus 11 from which the abnormalities were detected was transmitted was explained. However, in this embodiment, it is also applicable even when transmitting the command, which allows the manufacturing apparatus 11 from which abnormalities were detected to execute other processes.

In addition, in the above-mentioned example, although the apparatus discernment information and the command were properly described in the text of the electronic mail, it may be feasible to describe the apparatus discernment information and the command on the title or the header of the electronic mail. In addition, the apparatus discernment information and the command may be transmitted as an attached file of the electronic mail. In addition, the server apparatus 12 may accumulate the apparatus discernment information and the transmission status information into the prescribed address and may transmit the link information to the information of these to the client apparatus 13b via the electronic mail.

In addition, in the above-mentioned example, although the command was described in the position of the texts in the reply mail, which has been defined in advance, when describing the command in the text of the electronic mail, the command may be described with a tag, which shows that it is a command. For example, it is possible to describe the command including the tag <command> pressure_data</command> in any position of the texts. Here, the tag “<command> </command> ” shows that it is a command, and “pressure_data” shows that it is a command for acquiring data of pressure. The command is described as described above and the command execution section 1210 receives the command from the command information by searching the tag of the command. Thereby, the command can be correctly given to the manufacturing apparatus 12 irrespective of the description positions of the command.

In addition, when the transmissions and receptions of the abnormal notice information and the instruction information through the electronic mail are preferably encrypted by using a public key and/or a secret key to secure the security. Since the security system described above has already been utilized in the electronic mails, the cost for introducing the security system can be reduced by simply using this security system.

In addition, in the above-mentioned example, although the case where the electronic mail used for the transmission and reception of the abnormal notice information and the instruction information written in normal text e-mail was explained, in the present invention, the electronic mail may be what is called rich text mail, such as HTML e-mail. Since an input column is incorporable into the electronic mail column in such rich text e-mail, the command reception section 1303 can receive a command by putting a check into the input column of reply e-mail. For this reason, the user of the client apparatus 13 does not need to input a command as a text, and can reduce the user's process. In addition, in the server apparatus 12, since the kind of received command can be surely determined from the information in the input column of the reply e-mail, a malfunction by the user's miss input can be prevented. For example, it is acceptable to display a check box of “collecting measurement information” in the abnormal notice information and by only putting a check into this check box, the command reception section 1303 may be considered to have received the command for collecting the measurement information. In this case, in the server apparatus 12, when the check is marked in this check box for the instruction information, the reception of the command for executing “collecting measurement information” can be determined.

In addition, in the above-mentioned specific example, although the case where the number of the manufacturing apparatus 11 from which the abnormalities were detected was one was explained as the example, as mentioned above, the present invention is applicable even when the number of the manufacturing apparatus 11 from which the abnormalities were detected was plural. Especially when the number of the manufacturing apparatus 11 from which the abnormalities were detected was plural, it is preferable to include the apparatus discernment information of a plurality of the manufacturing apparatuses 11 from which the abnormalities were detected in the abnormal notice information, such as one electronic mail, to be transmitted to the client apparatus 13. In this case, it becomes possible to execute the process of the plurality of manufacturing apparatuses 11 from which the abnormalities were detected at one instruction by having the client apparatus 13 configure one command information and transmit it to the abnormal notice information, such as one electronic mail. For example, usually, in the production line of a semiconductor, since the production line is composed by a plurality of the manufacturing apparatuses 11, the abnormalities may be detected in a plurality of manufacturing apparatuses 11 at the same time. However, by doing in this way, it becomes unnecessary to individually output the command for executing a desired process on each of the plurality of manufacturing apparatus 11 from which the abnormalities were detected. In addition, while the burden of a user's process is eased, a prompt response is attained when abnormalities are detected.

As mentioned above, according to the embodiment of the present invention, when inputting the command for executing the process on the manufacturing apparatus in which the abnormalities has occurred, it is not necessary to input the apparatus discernment information of the apparatus in which the abnormality has occurred. In addition, the process by which a user inputs a command can be simplified, and the process for understanding the status of the abnormalities and the process for recovery can be performed quickly. In addition, in case when the user does not remember the apparatus discernment information, and the operation of a dedicated terminal of manufacturing apparatus is not fully mastered, it becomes possible to appropriately acquire the information on the status of manufacturing apparatus where abnormalities were detected. Thereby, after receiving the abnormal notice of the manufacturing apparatus, it becomes possible to respond appropriately and promptly. In addition, since the user does not need to remember the apparatus discernment information, user's burden is decreased.

In addition, according to apparatus of an embodiment of the present invention, since the client apparatus which becomes the addressee of the abnormal notice information can be set up for each apparatus discernment information in which abnormalities were detected using the transmission addressee information, a user, who is appropriate for the manufacturing apparatus in which abnormalities occurred can be selected, and the occurrence of the abnormalities can be notified. Unnecessary abnormal notice information cannot be transmitted to the users by this, and only required abnormal notice information can be transmitted.

In addition, according to an embodiment of the present invention, the status information, such as a log, for the manufacturing apparatus in which the abnormalities occurred, can be acquired by configuring the command information including the command for acquiring the status information of manufacturing apparatus, and the apparatus discernment information, which abnormal notice information includes, in the client apparatus which received abnormal notice information, and transmitting it to the server apparatus. For this reason, although the user neither adds nor inputs the information specifying the manufacturing apparatus to the command, the status information of the manufacturing apparatus from which abnormalities were detected is acquirable from the server apparatus. For this reason, it is possible to simplify the command to be inputted and to reduce the input process of the user. At the same time, it is possible to easily acquire the status information of the log of the manufacturing apparatus in which abnormality occurred. For this reason, the status of the manufacturing apparatus where the abnormalities were detected is appropriately analyzed, and it becomes possible to appropriately respond to the abnormality.

In addition, according to the an embodiment of the present invention, since the manufacturing apparatus corresponding to the apparatus discernment information can be updated corresponding to the update instructions information including the update information and the apparatus discernment information included in the abnormal notice information, the manufacturing apparatus in which abnormalities occurred can be easily updated without specifying the manufacturing apparatus 11, which is the target of the update.

In addition, according to the an embodiment of the present invention, since the server apparatus from which the abnormal notice information has been transmitted was set as the addressee and the server update information was transmitted, the operation for updating the server can be simplified.

In addition, since the transmission and the reception of abnormal notice information are performed by using the electronic mail, the server apparatus can be connect to Internet without using the dedicated terminal composed only for the server apparatus. Thus, it becomes possible to know the occurrence of abnormalities via electronic equipment, such as a computer capable of transmitting and receiving electronic mail, which has generally widely spread, and a cellular phone. Accordingly, the cost can be reduced. In addition, in case when there is a place where the transmission and reception of electronic mail are available, it becomes possible to conduct the abnormal detection and a recovery work without having to go to a place where a dedicated terminal is set. Thus it becomes possible to reduce user's labor and effort, and at the same time to shorten the time for the abnormal detection and a recovery process. In addition, the check of the occurrence of the abnormality can be easily performed without learning the operation of the dedicated terminal configured only for the server apparatus, using the electronic mail, which has widely spread. In addition, the apparatus discernment information included in the abnormal notice information, and the e-mail address of the server apparatus being the origin of the transmission are reusable to creation of the command information, update instructions information and transmission by creating the reply e-mail to this abnormal notice information.

In addition, according to an embodiment of the present invention, an server apparatus can be arranged to execute the command on the manufacturing apparatus corresponding to the apparatus discernment information included in the abnormal notice information by describing a command in the reply email of the abnormal notice information. Further, when inputting the command, it becomes possible to simplify the input for specifying the apparatus in which abnormality has occurred.

In addition, according to an embodiment of the present invention, by attaching update information to the reply email to the abnormal notice information, the manufacturing apparatus corresponding to the apparatus discernment information included in abnormal notice information can be updated, and a process of update of the manufacturing apparatus can be simplified.

In addition, according to an embodiment of the present invention, by attaching the server update information to the reply e-mail to the abnormal notice information, the server apparatus can be updated and a process of update of the manufacturing apparatus can be simplified.

In addition, as long as the correspondence relationship between the apparatus discernment information of the manufacturing apparatus 11 from which the abnormalities were detected, and the manufacturing apparatus 11 from which abnormalities were detected is maintained, the abnormal notice information configuration section 1206 may convert the apparatus discernment information of the manufacturing apparatus 11 from which the abnormalities were detected into desired apparatus discernment information. For example, it may be feasible to replace the apparatus discernment information of “E2” corresponding to the manufacturing apparatus 11b to, for example, an arbitrary numeral “005432”. In this case, the apparatus discernment information “E2” before the replacement and the apparatus discernment information “005432” after the replacement are correlated and stored into the memory. Then, the abnormal notice information in which the title and/or text including the arbitrary numeral “005432” will be transmitted to the client apparatus 13 from the server side transmission section 1208. And in case when the command information received by the command information receiving section 1209 from the client apparatus 13 includes this arbitrary numeric value “005432”, the apparatus discernment information “E2” corresponding to this arbitrary numeric value is acquired from the correspondence relationship of the apparatus discernment information of before and after the replacement stored in the memory, and it may be determined that it is a command information on the manufacturing apparatus 11 corresponding to “E2”. In addition, the apparatus discernment information may be the addressee information of the client apparatus 13 being the notifying destination of the abnormal notice information, for example, an e-mail address, and an IP address. This addressee information is acquirable from the addressee information per an apparatus stored in the addressee information storage section per apparatus 1207 by using apparatus discernment information as a search key in the same manner as the server side transmission section 1208. In addition, it is possible to use both the addressee information used in order to transmit abnormal notice information to the client apparatus 13 and the addressee information to be described in abnormal notice information. In such case, for example, when the command information is transmitted via an electronic mail from the client apparatus 13, the e-mail address of the client apparatus 13, which is an origin of the transmission, is usually included in the electronic mail of this command information as, for example, information of “Fom.” Therefore, by acquiring this e-mail address, and by acquiring the apparatus discernment information of the manufacturing apparatus 11 in which the abnormality has occurred corresponding to this e-mail address, the received command information can be determined that it is the command regarding the manufacturing apparatus in which the abnormality has occurred.

In addition, in each embodiment of the present invention described above, each process (each function) may be realized by a single apparatus (system), may be realized by being centrally processed or may be realized by a plurality of apparatuses conducting distributed processing.

In addition, in an embodiment of the present invention described above, each structural element may be configured by dedicated hardware, or for the structural element realizable by software it may be realized by executing a program. For example, each structural element may be realized by having program execution sections, such as CPU, read and execute the software program recorded on record media, such as a hard disk and semiconductor memory.

In addition, the software for realizing the group management system in each of the above-mentioned embodiment of the present invention is a following program. In another word, this program is a program to be executed on the server apparatus configuring a group management system having a function for performing the abnormal detection and including not less than one manufacturing apparatus for executing a prescribed process to a substrate to be processed, the server apparatus connected to not less than one manufacturing apparatus, and not less than one client apparatus connected to the server apparatus. The computer program includes a server side reception step for receiving status information being time series information pertaining to status of the manufacturing apparatus, an abnormal detection step for detecting occurrence of abnormality not less than one of manufacturing apparatuses including the manufacturing apparatus using a part of situation information received by the server side reception step, an abnormal notice information configuration step for configuring abnormal notice information, which is information having apparatus discernment information for discerning the manufacturing apparatus corresponding to at least one of the manufacturing apparatuses, in which the abnormality has occurred, and which is information notifying the abnormality, when the abnormal detection step has detected that the abnormality has occurred in any one of manufacturing apparatuses including the manufacturing apparatus, a server side transmission step for transmitting the abnormal notice information to the prescribed client apparatus, a command information reception step for receiving command information, which is information including a command performed in at least one manufacturing apparatuses having the abnormality, and including the apparatus discernment information, which the abnormal notice information includes, and a command execution step for executing a command included in the command information by utilizing the apparatus discernment information included in the command information.

The server side transmission step is a program for acquiring the addressee information corresponding to the apparatus discernment information of the manufacturing apparatus, in which the abnormality has occurred, corresponding to the addressee information per apparatus being the information including the stored apparatus discernment information and the addressee information being the information of the addressee of the client apparatus corresponding to the apparatus discernment information, and is arranged to transmit the abnormal notice information by using the acquired addressee information.

Further, in case when a command included in the command information is a command to be executed by the manufacturing apparatus, the command execution step is a program for allowing the computer to further execute a manufacturing apparatus command information transmission step for transmitting the manufacturing apparatus command information configured by the command execution step to the manufacturing apparatus corresponding to the apparatus discernment information included in the command information by configuring the manufacturing apparatus command information including the command.

In addition, the command is a command for acquiring at least a part of the status information, and is a program for allowing a computer to execute an accumulation step for correlating the status information received by the server side reception section with the apparatus discernment information corresponding to the status information and accumulating them into the status information storage section, a transmission status information configuration step for configuring the transmission status information being the status information for transmission by acquiring at least a part of the status information accumulated in the accumulation step correlated to the apparatus discernment information included in the command information corresponding to an instruction of the command execution section, and a transmission status information transmission step for transmitting the transmission status information configured in the transmission status information configuration step to the client apparatus from which the command information has been transmitted.

Further the command is a program for further executing an update instruction information reception step for receiving the update instruction information including the update information being information for updating the manufacturing apparatus and the apparatus discernment information included in the abnormal notice information, and an update information transmission step for transmitting the update information included in the command information to the manufacturing apparatus corresponding to the apparatus discernment information included in the update instruction information.

Further, the command is a program for further executing a sever update information reception step for receiving the server update information being the information for allowing the server apparatus to execute the update, and a server update execution step for executing update by using the server update information.

In addition, the computer program includes a function for transmitting the abnormal notice information by using an electronic mail.

In addition, the reception of the command information is performed using an electronic mail, and the command information is a program which is arranged to describe the command received by the command reception section into the reply e-mail corresponding to the abnormal notice information which specifies the server apparatus from which the abnormal information has been sent as the addressee.

In addition, the transmission of the abnormal notice information and the reception of the update instructions information are performed using an electronic mail and the update instructions information is a program for attaching server update information to the reply e-mail, which has the apparatus discernment information included in the abnormal notice information, corresponding to the abnormal notice information specifying the server apparatus from which the abnormal information has been sent as the addressee.

In addition, transmission of the abnormal notice information and reception of the server update instructions information are performed using an electronic mail and the server update instructions information is a program for attaching server update information to the reply e-mail corresponding to the abnormal notice information specifying the server apparatus, from which the abnormal notice information has been sent, as the addressee.

In addition, in the above-mentioned program, at the transmission step for transmitting information, and the reception step for receiving information, the process performed by hardware, for example, the process performed by a modem and interface card in the transmission means, (process performed only by hardware) is not included.

In addition, this program may be executed by downloading from a server, and may be executed by reading the program recorded on prescribed record medium (for example, optical disks, such as CD-ROM, a magnetic disk, and semiconductor memory).

In addition, the number of the computer executing this program may be singular or plural. Namely, a central processing or a distributed processing may be performed.

In addition, in the embodiment of the present invention, it is apparent that two or more means of communications (such as information transmitting section), which exist in one apparatus, may be physically realized by one medium.

The present invention is not limited to the above embodiment and various changes are possible, which are apparently included in the scope of this invention.

As mentioned above, the group management systems related to the present invention are suitable for semiconductor manufacturing, a group management system including manufacturing apparatus, such as a flat-panel display, and especially useful as a group management system for performing the abnormal detection of the manufacturing apparatus.

What is claimed is:

1. A group management system having a function for performing abnormal detection, the group management system comprising:
at least one manufacturing apparatus for executing a prescribed process to a substrate to be processed;
a server apparatus connected with the manufacturing apparatus; and
at least one client apparatus connected with the server apparatus,
wherein the manufacturing apparatus includes
a status information acquisition section for acquiring status information, which is time series information on a status of the manufacturing apparatus, and
a status information transmission section for transmitting the status information, which the status information acquisition section has acquired;
wherein the server apparatus includes
a server side reception section for receiving the status information,
an abnormal detection section for detecting occurrence of abnormality in respect to the manufacturing apparatus using at least a part of status information, which the server side reception section has received,
an abnormal notice information configuration section for configuring abnormal notice information, which is information having at least one apparatus discernment information being information for discerning the manufacturing apparatus corresponding to the manufacturing apparatuses, in which the abnormality has occurred, and is information for notifying the abnormality, when the abnormal detection section has detected that the abnormality has occurred in any one of the manufacturing apparatuses,
a server side transmission section for transmitting the abnormal notice information to prescribed the client apparatus,
a command information reception section for receiving command information, which is information including a command performed in the manufacturing apparatuses in which the abnormality has occurred, and including the apparatus discernment information, which the abnormal notice information includes,
a command execution section for executing a command included in the command information by utilizing the apparatus discernment information included in the command information; and
wherein the client apparatus includes
a client side reception section for receiving the abnormal notice information,
an output section for outputting the abnormal notice information, which the client side reception section received,
a command reception section for receiving the command,
a command information configuration section for configuring the command information using a command received by the command reception section and the apparatus discernment information which is included in the abnormal notice information, and
a command information transmission section for transmitting the command information to the server apparatus.

2. The group management system of claim 1,
wherein the server apparatus further includes
an addressee information per apparatus storage section, which is capable of storing information being information including the apparatus discernment information and addressee information, which is information of addressee of the client apparatus corresponding to the apparatus discernment information,
wherein the server side transmission section acquires the addressee information corresponding to the apparatus discernment information of the manufacturing apparatus, in which the abnormality has occurred, in response to the addressee information per apparatus, and transmits the abnormal notice information by utilizing the addressee information, which has been acquired.

3. The group management system of claim 1,
wherein the command execution section of the server apparatus configures manufacturing apparatus command information including a command, when the command included in the command information is a command to be executed by the manufacturing apparatus;
wherein the server apparatus further comprises a manufacturing apparatus command information transmission section for transmitting manufacturing apparatus command information, which has been configured by the command execution section to the manufacturing apparatus corresponding to the apparatus discernment information included in the command information; and
wherein the manufacturing apparatus further comprises a manufacturing apparatus command information reception section for receiving the manufacturing apparatus command information and
a process section for executing a command included in the manufacturing apparatus command information.

4. The group management system of claim 1,
wherein the command is a command, which acquires at least a part of the status information;
wherein the server apparatus further comprises
a status information storage section into which the status information and the apparatus discernment information are stored;
an accumulation section for correlating the status information, which the server side reception section received, and the apparatus discernment information corresponding to the status information, and for accumulating correlated information into the status information storage section;
a transmission status information acquisition section for acquiring at least a part of status information, which has been correlated with the apparatus discernment information included in the command information corresponding to instructions of the command execution section, and has been stored in the status information storage section, and for configuring transmission status information, which is status information for transmission; and
a transmission status information transmission section, which transmits transmission status information configured by the transmission status information acquisition section to a client apparatus, from which the command information was transmitted, and
wherein the client apparatus further comprises
a status information reception section for receiving the transmission status information, and
a status information output section for outputting transmission status information received by the status information reception section.

5. The group management system of claim 1,
wherein the client apparatus further comprises
an update information reception section for receiving update information, which is information for updating the manufacturing apparatus,
an update instruction information configuration section for configuring update instruction information including update information received by the update information reception section, and the apparatus discernment information included in abnormal notice information received by the client side reception section, and
an update instruction information transmission section for transmitting the update instruction information to the server apparatus;
wherein the server apparatus further comprises
an update instruction information reception section for receiving the update instruction information, and
an update information transmission section for transmitting update information included in the command information to the manufacturing apparatus corresponding to apparatus discernment information included in the update instruction information; and
wherein the manufacturing apparatus further comprises
an update information reception section for receiving the update information, and
an update execution section for executing update information, which has been received by the update information reception section.

6. The group management system of claim 1,
wherein the client apparatus further comprises
a server update information reception section for receiving server update information, which is information for the server apparatus to execute update and
a server update information transmission section for transmitting the server update instruction information to the server apparatus; and
wherein the server apparatus further comprises
a server update information reception section for receiving the server update information, and
a server update execution section for executing update by using the server update information.

7. The group management system of claim 1,
wherein transmission and reception of the abnormal notice information are conducted via an electronic mail.

8. The group management system of claim 7,
wherein transmission and reception of the command information are conducted via an electronic mail, and the command information configuration section configures the command information describing a command received by the command reception section in a reply e-mail corresponding to the abnormal notice information, the reply e-mail being specified to be sent to the server apparatus, from which the abnormal notification information was transmitted.

9. The group management system of claim 5,
wherein transmission and reception of the abnormal notice information and transmission and reception of the update instruction information are conducted via an electronic mail, and the update instruction information configuration section configures the update instruction information, to which the update information is attached, in a reply e-mail having apparatus discernment information included in the abnormal notice information corresponding to the abnormal notice information, the reply e-mail being specified to be sent to the server apparatus, from which the abnormal notice information was transmitted.

10. The group management system of claim 6,
wherein transmission and reception of the abnormal notice information and transmission and reception of the server update instruction information are conducted via an electronic mail, and the server update instruction information configuration section configures the server update instruction information, to which the server update information received by the server information reception section is attached, in a reply e-mail corresponding to the abnormal notice information, the reply e-mail being specified to be sent to the server apparatus, from which the abnormal notice information was transmitted.

11. The group management system of claim 7,
wherein transmission and reception of the electronic mail are conducted under a coded condition.

12. The group management system of claim 7,
wherein the transmission of the electronic mail is conducted by specifying an addressee with an e-mail address.

13. A server apparatus, which configures a group management system having a function for performing abnormal detection, the group management system including
at least one manufacturing apparatus for executing a prescribed process to a substrate to be processed, the manufacturing apparatus being connected with the server apparatus, and
at least one client apparatus connected with the server apparatus, the server apparatus comprising:
a server side reception section for receiving status information being time series information pertaining to status of the manufacturing apparatus;
an abnormal detection section for detecting occurrence of abnormality in respect to the manufacturing apparatus using at least a part of status information received by the server side reception section;
an abnormal notice information configuration section for configuring abnormal notice information, which is information having at least one apparatus discernment information for discerning the manufacturing apparatus corresponding to the manufacturing apparatuses, in which the abnormality has occurred, and is information notifying of the abnormality, when the abnormal detection section has detected that the abnormality has occurred in any one of the manufacturing apparatuses;
a server side transmission section for transmitting the abnormal notice information to prescribed the client apparatus;
a command information reception section for receiving command information, which is information including a command performed in the manufacturing apparatuses in which the abnormality has occurred, and including the apparatus discernment information, which the abnormal notice information includes; and
a command execution section for executing a command included in the command information by utilizing the apparatus discernment information included in the command information.

14. The server apparatus of claim 13 further comprising:
an addressee information per apparatus storage section, which is capable of storing addressee information per apparatus being information including the apparatus discernment information and the addressee information, which is information of addressee of the client apparatus corresponding to the apparatus discernment information,
wherein the server side transmission section acquires the addressee information corresponding to the apparatus discernment information of the manufacturing apparatus, in which the abnormality has occurred, in response to the addressee information per apparatus and transmits the abnormal notice information by utilizing the addressee information, which has been acquired.

15. The server apparatus of claim 13 further comprising:
a status information storage section into which the status information and the apparatus discernment information are stored;
an accumulation section for correlating the status information received by the server side receiving section, and the apparatus discernment information corresponding to the status information, and for accumulating correlated information into the status information storage section;
a transmission status information acquisition section for acquiring at least a part of status information, which has been correlated with the apparatus discernment information included in the command information corresponding to instructions of the command execution section, and has been stored in the status information storage section, and for configuring transmission status information, which is status information for transmission; and
a transmission status information transmission section, which transmits transmission status information configured by the transmission status information acquisition section to a client apparatus, from which the command information was transmitted,
wherein the command is a command, which acquires at least a part of the status information.

16. The server apparatus of claim 13 further comprising:
an update instruction information reception section for receiving update instruction information, which includes update information being information for updating the manufacturing apparatus, and apparatus discernment information included in the abnormal notice information; and
an update information transmission section for transmitting update information included in command information to the manufacturing apparatus corresponding to the apparatus discernment information included in the update instruction information.

17. The server apparatus of claim 13 further comprising:
a server update information reception section for receiving server update information for the server apparatus to execute update; and
a server update execution section for executing the update by using the server update information.

18. The server apparatus of claim 13,
wherein transmission of the abnormal notice information is conducted via an electronic mail.

19. The server apparatus of claim 18,
wherein reception of the command information is conducted by an electronic mail and the command information is configured by describing a command received by the command reception section in a reply e-mail corresponding to the abnormal notice information, and the addressee of the reply e-mail being the server apparatus from which the abnormal notice information has been transmitted.

20. The server apparatus of claim 16,
wherein transmission of the abnormal notice information and reception of the update instruction information are conducted by an electronic mail, and the update instruction information is configured by attaching the update information to a reply e-mail including apparatus discernment information included in the abnormal notice information corresponding to the abnormal notice information, and the addressee of the reply e-mail being the server apparatus from which the abnormal notice information has been transmitted.

21. The server apparatus of claim 17,
wherein transmission of the abnormal notice information and reception of the server update instruction information are conducted by an electronic mail, and the sever update instruction information is configured by attaching the sever update information to a reply e-mail corresponding to the abnormal notice information, and the addressee of the mail being the server apparatus from which the abnormal notice information has been transmitted.

22. A computer program for being executed on a server apparatus configuring a group management system having a function for performing abnormal detection, the group management system including at least one manufacturing apparatus for executing a prescribed process of a substrate to be processed, and at least one client apparatus being connected to the server apparatus the server apparatus being connected to the manufacturing apparatus, the computer program comprising:
a server side reception step for receiving status information being time series information pertaining to status of the manufacturing apparatus;
an abnormal detection step for detecting occurrence of abnormality of the manufacturing apparatuses using at least a part of status information received by the server side reception step;
an abnormal notice information configuration step for configuring abnormal notice information, which is information having at least one apparatus discernment information for discerning the manufacturing apparatus corresponding to the manufacturing apparatuses, in which the abnormality has occurred, and is information notifying of the occurrence of the abnormality, when the abnormal detection step has detected that the abnormality has occurred in any one of the manufacturing apparatus;
a server side transmission step for transmitting the abnormal notice information to prescribed the client apparatus;
a command information reception step for receiving command information, which is information including a command performed in the manufacturing apparatuses in which the abnormality have occurred, and including the apparatus discernment information, which the abnormal notice information includes; and
a command execution step for executing a command included in the command information by utilizing the apparatus discernment information included in the command information.
